(19) United States
(12) Patent Application Publication
(10) Pub. No.: US 2026/0105905 A1
(43) Pub. Date: Apr. 16, 2026

(54) DYNAMIC SIGNAL PROCESSING SYSTEM FOR ENVIRONMENTAL AND CONTEXTUAL ACOUSTIC OPTIMIZATION

(71) Applicant: Alpha Studio Platform Co., Inc., Mill Valley, CA (US)

(72) Inventors: Charles A.G. BOYLE, San Francisco, CA (US); Timothy B. SOUTHORN, London (GB)

(21) Appl. No.: 19/288,522

(22) Filed: Aug. 1, 2025

Related U.S. Application Data
(60) Provisional application No. 63/706,184, filed on Oct. 11, 2024.

(51) Int. Cl. G10K 11/178

(52) U.S. Cl. CPC G10K 11/17823; G10K 11/17873; G10K 2210/3024; G10K 2210/3027; G10K 2210/3047; G10K 2210/3216

(57) ABSTRACT

Audio output signals and audio cancellation output signals are generated based on source audio signals. Audio speakers are driven with the audio output signals to generate audio output sound waves that are propagated to a specific audience area. Audio cancellation speakers are driven with the audio cancellation output signals to generate audio cancellation output sound waves. The audio cancellation output sound waves reduce, in non-audience areas, a sound dispersion caused by the audio output sound waves. The audio output signals or the audio cancellation output signals are adjusted in real time in response to sensor based control signals. The sensor based control signals are generated from real time sensor data acquired by and collected from physical sensors deployed in a space including the specific audience area and the non-audience areas.

### CROSS-REFERENCE TO RELATED APPLICATIONS

This application claims priority to U.S. Provisional Patent Application No. 63/706,184, “Dynamic Signal Processing System for Environmental and Contextual Acoustic Optimization”, filed on Oct. 11, 2024, the contents of which are hereby incorporated by reference in its entirety.

### TECHNICAL FIELD

Embodiments relate generally to signal processing and, more particularly, to computational audio.

### BACKGROUND OF THE INVENTION

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

In this era of high-density living and open workspace environments, sound pollution is a significant issue. Unwanted sound transmission can cause discomfort, lower productivity, waste energy, restrict operations, violate local and neighborhood noise ordinances, and lead to significant legal and other related issues.

### BRIEF DESCRIPTION OF DRAWINGS

The present disclosure is illustrated by way of example, and not by way of limitation, in the figures of the accompanying drawings and in which like reference numerals refer to similar elements and in which:

FIG. 1 illustrates a top view of an example audio event venue;

FIG. 2 illustrates example prevention of noise pollution.

FIG. 3 illustrates an example subwoofer with a natural omnidirectional sound radiation pattern;

FIG. 4 illustrates an example speaker array of a subwoofer and cancellation subwoofer and an associated sound radiation pattern;

FIG. 5 illustrates an example cancellation subwoofer placed in a specific spatial direction from a subwoofer;

FIG. 6 illustrates a first example graph having two sound waves generated by two different speakers;

FIG. 7 illustrates a second example graph having two sound waves generated by two different speakers;

FIG. 8 illustrates an example control system;

FIG. 9 illustrates example determination of a model of a venue;

FIG. 10 illustrates an example process flow for measuring magnitude and phase responses of an audio speaker or loudspeaker;

FIG. 11 illustrates example operations relating to exponential Sine sweep (ESS);

FIG. 12 illustrates an example Fourier transform process;

FIG. 13 illustrates example application of window functions;

FIG. 14 illustrates example impulse response (IR) windowing operations;

FIG. 15 illustrates an example process flow in impulse response generation;

FIG. 16 illustrates an example of a generic computer device 900 and a generic mobile computer device 950 upon which embodiments of the disclosure may be implemented; and

FIG. 17A through FIG. 17D illustrate example process flows.

### DETAILED DESCRIPTION OF THE INVENTION

In the following description, for the purposes of explanation, numerous specific details are set forth in order to provide a thorough understanding of the present disclosure. It will be apparent, however, that the present disclosure may be practiced without these specific details. In other instances, well-known structures and devices are shown in block diagram form in order to avoid unnecessarily obscuring the present disclosure.

Embodiments are described herein according to the following outline:
1.0. General Overview
2.0. Structural Overview
   2.1. Sound Pollution
   2.2. Cancellation Speakers in Propagation Paths
   2.3. Close Proximity Cancellation Speakers
   2.4. Directional Cancellation
   2.5. Sound Control System
   2.6. Signal Processing and Monitoring
   2.7. Energy Efficiency and Power Conservation
   2.8. Operational Control
   2.9. AI and ML Enabled Operations
   2.10. Example System or Platform Functions
   2.11. Autonomous Mitigation of Partial System Failure
   2.12. Optimizing Speech Intelligibility in Emergency Scenario
   2.13. Operational and Environmental Data
3.0 Example Process Flows
4.0. Implementation Mechanism—Hardware Overview
5.0. Extensions and Alternatives

### 1.0. General Overview

Techniques as described herein can be used to improve and contain intended audio sound in target areas/spaces, and to alleviate or avoid sound pollution in other areas/spaces adjacent to or away from the target areas/spaces by minimizing sound propagation beyond the predefined target areas/spaces, thereby creating a significant benefit in the overall environment including the target areas/spaces and other areas/spaces.

Under other approaches, relatively high end sound systems are unnecessarily intricate and create implementation and configuration challenges. The complexity of the system designs makes them burdensome to execute. For example, system configurations for audio events may need to be performed largely manually by expert practitioners skilled in the art of audio engineering and other related domains.

In comparison, a (e.g., contained sound, sound containment to specific target areas, sound pollution avoidance, etc.) system as described herein can solve or mitigate these problems or issues by utilizing and implementing audio engineering approaches combined with relatively innovative relatively efficient (e.g., automatically performed, with little or no user input, with little or no user manipulation in the field operations, etc.) equipment configurations to optimize audio outputs of various audio components/devices/systems in the overall system and limit sound propagation beyond desired or target sound containment areas.

Objective testing has been or can be successfully performed or conducted to demonstrate or verify technical thesis or operational principles that sound can be contained as designed or specified with the system. In the field or for various audiovisual events, the system can be used or deployed to automatically, or in a relatively simple manner with no or little user input or manipulation, configure and control the audio output or sound of the audio components, devices or systems and/or to contain the audio output or (human perceptible) sound and/or to reduce or eliminate the need for skilled operators to configure or operate the system.

Techniques as described herein may be used to implement or support a multitude of audio, sound or audiovisual applications, such as audio system design, planning and simulation from relatively (e.g., very, etc.) small to relatively (e.g., very, etc.) large scale. Some of these applications may be implemented for the purpose of enhancing existing audio components, devices or systems as well automating new or future audio product designs. A contained sound system as described herein can include or implement a dynamic monitoring capability that can continuously monitor sound levels at various spatial locations and various frequency ranges or sub-ranges in an audio or audiovisual event/venue such as a music festival or a night club. Additionally, optionally or alternatively, the system can operate to dynamically adjust audio settings in real time, effectively minimizing (e.g., relatively excessive, etc.) or significantly reducing sound leakage.

Under techniques as described herein, digital modeling and sound propagation predictions may be performed to enable design and configuration of an audiovisual system as described herein in advance and provide representations of expected outcomes that align with real-world results.

Artificial intelligence (AI) and/or machine learning (ML) based models may be trained and/or applied for sound optimization operations as described herein. The AI/ML models can be used to simulate and analyze real-time sound propagation patterns and intelligently optimize sound outputs of the system incorporating or operating in conjunction with these AI/ML models. The system or the AI/ML models may learn about or from (e.g., physical sensors/probes deployed in, etc.) an actual (e.g., physical, geographic, topographic, three-dimensional or 3D spatial, two-dimensional or 2D spatial, etc.) environment and fine-tune the system based on information or insights learned, estimated or predicted from these (e.g., at least partially, data-driven, etc.) AI/ML models.

Real-time sound adaptation may be performed with or by the system. For example, the system or audio output generated/controlled thereby may dynamically adapt to changes in the physical audiovisual environment, such as new or updated objects that could affect acoustics related environmental changes such as temperature or humidity, or changes in the ambient noise level, relative to underlying audio or sound propagation objectives including but not limited to minimizing or (e.g., actively, etc.) canceling unwanted noise.

The system may be implemented to be manufacturer agnostic or operate with a wide variety of sound equipment (e.g., speakers, audio controllers, sensors/probes, etc.) designs and/or models and/or batches from different manufacturers. Additionally, optionally or alternatively, the system can include, integrate or operate with different types of audio systems, including but not limited to: some or all of: public address systems, workplace installations, and personal computing devices, effectively integrating components from a single or many different manufacturers.

Different types of user interface components or controls may be included or implemented with or by the system. For example, a (e.g., user-friendly, graphic based, haptics based, relatively intuitive, etc.) UI subsystem may be implemented with the system to enable users to set or achieve their preferred or target listening areas and listening objectives relatively easily and efficiently.

Relatively high energy efficiency in audio output may be achieved with the system, for example, by focusing or delivering sound only in target areas, as needed, intended or targeted and by taking advantage of contextually relevant optimizations. The system may apply or implement contained sound or sound containment to optimizes power usage/consumption, thereby contributing to relatively high energy conservation or efficiency.

In some operational scenarios, the audio event hosted at the venue may be subjected to noise control regulations or rules, such as running a music festival or a nightclub which may have problems with noise affecting neighbors. The system as described herein can be deployed to host such an audio event and reduce or eliminate noise pollution to designated non-audience areas. As a result, the music festival or nightclub can stay open later or longer, thereby increasing operational flexibility and efficiency.

Approaches, techniques, and mechanisms are disclosed for real-time sound reproduction and adjustment. One or more audio output signals and one or more audio cancellation output signals are generated based at least in part on one or more source audio signals. One or more audio speakers are driven with the one or more audio output signals to generate audio output sound waves that are propagated to at least a specific audience area. One or more audio cancellation speakers are driven with the one or more audio cancellation output signals to generate audio cancellation output sound waves. The audio cancellation output sound waves reduce, in one or more non-audience areas, a sound dispersion caused by the audio output sound waves. One or more of the audio output signals or the audio cancellation output signals are adjusted in real time in response to one or more sensor based control signals. The one or more sensor based control signals are generated at least in part from real time sensor data acquired by and collected from one or more physical sensors deployed in a space including the specific audience area and the one or more non-audience areas.

In other aspects, the disclosure encompasses computer apparatuses and computer-readable media configured to carry out the foregoing techniques.

### 2.0. Structural Overview

A system under techniques as described herein can provide or support straightforward orchestration of numerous (e.g., up to 5, 10, 100 or more, etc.) relatively complex processes, adaptively managing sound reproduction to deliver relatively high or the highest sound quality of reproduced sound in specific target areas/venues and to minimize pollution or negative impact of sound propagating to other areas not designated for sound.

The system can autonomously and dynamically adjust its configuration in real time operations, depending on real-time audio measurements and environmental information, contextual needs associated with sound reproduction, operational objectives, and adaptively combine a relatively high number of control inputs (and/or user inputs if received), weighting respective contributions to maintain a valid operating state, and reduce operational complexities and costs. Some or all these control inputs data may be collated or combined into a real time operational model, representation or visualization of an audio event being hosted at the venue. Coherence values may be estimated, computed or determined for these control inputs and used to weigh the control inputs'respective contributions into average or aggregated or combined values to be used in the real time operational model, representation or visualization.

Auxiliary sensor devices equipped with up to a relatively high number of physical sensors may be included or may operate with the system. Some or all of these auxiliary sensor devices may include their own processing capability, supporting data collection and metadata generation, such as those associated with audio and/or environmental measurements, and support internal and/or external data transmission and reception with the system or other devices using one or more in a variety of communication transports or channels.

Defining sound quality is difficult because there are no universally agreed-upon standards for what constitutes “good” or “bad” sound. While certain technical measurements, such as frequency response, distortion, or signal-to-noise ratio, offer objective ways to evaluate audio performance, these metrics do not always align with subjective listener preferences.

The apparent loudness of a sound system is often regarded by laypeople as a quality metric. However, loudness is a subjective measure relating to psychoacoustics. Listeners often attempt to compensate for perceived poor quality sound reproduction by increasing the sound level. This behavior may be related to the sensitivity of the human ear changing as a function of frequency. While the result may improve the perception of frequencies in ranges where the ear is less sensitive, it may adversely affect sound reproduction in objective ways such as introducing or increasing distortion and noise. Increasing the sound level can also increase sound propagation further from the audio or source depicted in the sound reproduction, which may be considered noise pollution in many operational scenarios. It can be appreciated that high-fidelity sound reproduction does not encourage this behavior of raising volume to improve perception. In comparison, the system under techniques as described herein can provide or generate relatively high-fidelity sound reproduction that does not need to be loud and/or generate noise pollution for other areas away from the specific designated areas/venues.

Distortion and noise are often considered undesirable characteristics in high-fidelity sound reproduction. However, they are sometimes intentionally added to audio signals for psychoacoustic effect. For example, distortion can be used to enhance the harmonic content of a signal, increasing its perceived loudness and presence, and noise can be used to mask undesired sound.

In some operational scenarios, the system as described herein can provide or support controlled distortion and noise generation processes to generate or produce target or intended psychoacoustic effects. The system may implement or perform operations relating to harmonic synthesis to leverage the missing fundamental phenomenon, in which the perception of relatively low frequencies is enhanced without physically emitting them. For example, the lowest frequency component or fundamental in a harmonic series can be removed, while higher frequency components in the harmonic series can be preserved, to reduce overall energy consumption in sound reproduction with no or little audio perception problems. The system may add synthesized higher harmonics to create the illusion of low frequency reproduction for the purpose of providing benefits in multiple use cases. For example, when the level of relatively low frequencies is the cause of a complaint outside an intended or target listening area/venue, and is to be attenuated, harmonic synthesis can be employed by the system to reduce the perceived difference for those inside the intended or target area/venue. In addition, reducing the amplification of the low frequencies will reduce the energy usage and consumption of the overall sound reproduction system. In other words, the missing fundamental phenomenon may be exploited or implemented with the system to increase perceived loudness while reducing overall acoustic energy, as the fundamental—typically requiring more acoustic energy than higher harmonics to achieve the same perceived loudness—is removed. This can reduce leaked off-site audio volume beyond the audience area.

Under other approaches, psychoacoustic processes such as those relating to harmonic synthesis—though dynamic in their effect—are typically statically configured and/or operate independently of one another.

Under these approaches, modeling and simulation may be used (e.g., well ahead of the event, etc.) to produce, at best, an approximation of the effective result. Available tools for the design and configuration of sound reproduction systems are often limited by their generality, or specific focus on a particular function. Relatively sophisticated tools are often manufacturer-specific, severely limiting their use in the design of heterogeneous systems. Most if not all these tools are primarily concerned with predicting sound reproduction for intended listeners, with little or minimal consideration of optimizing or preventing sound propagating or pollution to other areas outside specific designated areas/venues and to listeners who do not wish to hear it.

While audio engineers may use numerous tools in design, configuration, and operation of one or more sound reproduction systems, these tools are rarely (e.g., fully, etc.) integrated and heavily depend upon the skill of the practitioners to use them together to their maximum effect. Furthermore, the “human-in-the-loop” or a large amount of human intervention and input introduces latency and bias in operating these tools to design and configure corresponding sound reproduction systems.

In comparison, the system as described herein can be implemented to perform automatic, dynamic, realtime and coordinated signal processing to produce target spatial audio effects leveraging psychoacoustic phenomena such as comb-filtering and the precedence effect. The system can be used to provide or support relatively intelligent dynamic orchestration of processes or operational parameters, in response to or based at least in part on audio and environmental (e.g., measurement, aggregated, collected, analytical, etc.) data and temporally varying contextual needs to be met by reproduced sound or sound images/fields.

In a non-limiting example, for active (noise pollution) cancellation, subwoofer arrays can be used to reduce or cancel wave fronts (in terms of magnitude or intensity)—of noise pollution from sound reproduction at the venue—that are propagating to a specific non-audience area. Sets of filters or digital signal processors (DSPs) may be used to generate audio cancellation signals used to drive the subwoofers that are used to create cancelling or cancellation waves or wave fronts. These filters or DSPs' operational parameters may be dynamically orchestrated or set by the system in response to real time tracked or monitored environmental conditions as well as audio contents (e.g., frequencies, magnitudes, phases, etc.) in the sound reproduction in real time. In some operational scenarios, trained or pre-trained AI/ML based models may be used to perform some or all of the operational parameter orchestration or setting. These AI/ML models may use the tracked or monitored environmental conditions and/or audio contents as input and generate optimized values for the operational parameters as outputs, predictions or estimations.

A wide range of designs and configurations of heterogeneous sound (e.g., reproduction, etc.) systems or components may be integrated, coordinated or controlled by the system as described to support sound reproduction in various operational scenarios. Examples of sound systems or components operating with the system may include, but are not necessarily limited to only, any, some or all of: loudspeakers, including for example haptic transducers to generate tactile response, and induction loops to activate telecoils in assistive hearing devices.

These sound (reproduction) systems or components may be sourced from more than one manufacturer. The system can implement or support designing an overall integrated sound reproduction system that uses each (sub) system or component to its best effect as part of a cohesive whole.

The system may be implemented with a “closed-loop” design that continuously and automatically optimizing (e.g., dynamic, realtime, with no or little user invention or input, audio, etc.) signal processing in response to or based at least in part on real-time audio and environment measurements or data to minimize or avoid undesirable variance from intended audio reproduction outcomes. The system may be implemented to support designing, configuring, and operating (e.g., relatively, etc.) high-fidelity sound reproduction systems that provide sound reproduction and containment in a manufacturer agnostic manner.

In some operational scenarios, in which a sound system or component's performance differs from its manufacturer specifications, or in which component specifications are not available, their measured output may be performed, collected and analyzed in real time. The measured output as well as analytical results can be provided to and used by the system to integrate the sound system or component into overall sound reproduction and/or containment operations in real time. As a result, the system can model and enable relatively advantageous—which may be previously non-viable—configurations, even if not envisaged by equipment manufacturers.

In addition to compensating for divergence from expected performance when designing and configuring a sound reproduction system in realtime or non-realtime operations, the system can also be implemented to analyze and mitigate (e.g., temporally varying, gradually occurring, temporary, etc.) performance degradation associated with the sound reproduction system.

In some operational scenarios, the “closed-loop” system as described herein can detect undesirable (e.g., audio, sound reproduction, audibly perceptible, psychoacoustic, etc.) artifacts present in audio outputs. The detection may be made with audio or environment measurements or data collected in real time by auxiliary or attendant sensors operating in conjunction with the system. Example artifacts may include, but are not necessarily limited to only, audio distortion resulting from sound reproduction systems/components being driven beyond their operating limits. By processing the available or collected real time data, the system can infer causes of such artifacts and autonomously mitigate them, for example by dynamically attenuating particular frequencies that are causing speaker breakup or attenuating overall signal input levels to amplifiers with insufficient power supply.

Additionally, optionally or alternatively, the system can compensate for changes over relatively long periods of time. As sound systems or components age, their performance characteristics change, a process known as “break-in”, increasingly diverging from the specifications of a newly manufactured product. Sound reproduction systems or components are commonly constructed with materials such as paper, wood, and metals, and so are susceptible to further changes in their performance characteristics over time due to processes such as hydrolysis, corrosion, and oxidation. The system can perform automatic or autonomous operations to maintain desired listening experiences over time, even as sound systems and components degrade or deviate from their specifications, thereby delivering relatively numerous significant benefits. For example, maintenance cycles for the systems or components can be extended, while relatively expensive servicing events such as recalibration of a system to restore performance in line with the initial configurations or specifications can be minimized. Operational data collected and/or analyzed by the system over time can be used to estimate or predict system or component failure and support timely scheduling of preventative maintenance with no or minimal disruption to field operations and reducing or preventing the risk of operational failures during an event can help avoid relatively high cost consequences.

In some operational scenarios, realtime or historical operational data collected or analyzed by the system may serve as input for (e.g., trained, pre-trained, etc.) AI/ML based prediction models to support modeling, estimating or predicting effects of system or component aging, water damage, and so on, as well as used to (e.g., continuously, over time, etc.) improve these AI/ML model operating with or included in the system and enable upgraded performance or performance updates. Insights developed from the improved AI/ML models can support refinement of manufacturer-provided default configurations and/or utility in loudspeaker design and development, enhancing effectiveness of the overall system from design to operation.

### 2.1 Sound Pollution

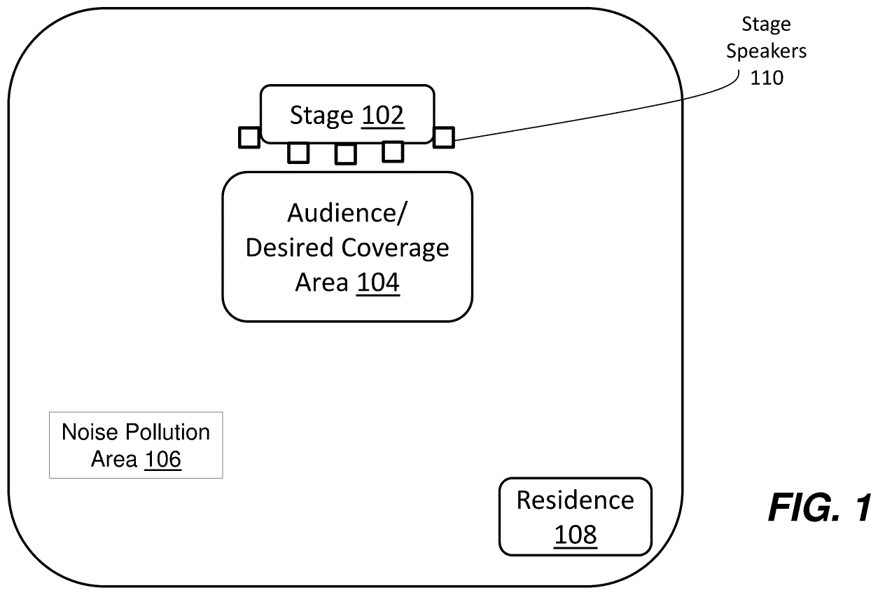

FIG. 1 illustrates a top view of an example audio (event) venue. As shown, the venue has a stage 102 with audio speakers outputting or reproducing sound (e.g., pressure waves, etc.) to (e.g., audience or intended listeners in, etc.) an audience area 104 in front of the stage 102. A performer can be on the stage 102 as an original sound source. A high quality audio output corresponding to (e.g., acquired and amplified from, etc.) the performer's original sound source can be generated by stage speakers 110 and intentionally directed towards the audience in the audience area 104. The stage 102 and the audience area 104 are surrounded by a (pattern filled) noise pollution area 106 that is not associated with the performer and audience. The sound generated or originated from the stage 102 or leakage thereof can be—considered as noise pollution—undesirable in the noise pollution area 106. For example, this surrounding noise pollution area 106 may include a residence area 108 where residents living or working in buildings or spaces do not wish to be disturbed by the sound from the stage 102.

In some operational scenarios, relatively high and medium frequency audio signals or sound waves from the stage 102 may not travel past or far away from the audience area 104. However, relatively low frequency sounds or sound waves may have relatively long wavelengths comparable to spatial dimensions of obstacles in between the audience area 104 and the noise pollution area 106, which allows the sound waves from the stage 102 to diffract around the obstacles and reach spatial regions—for example, some or all of the noise pollution area 106—that the relatively high frequency sounds or sound waves would not. Just as low frequency radio waves can diffract over mountains and travel beyond the horizon, low frequency sound waves are less likely to be absorbed by objects.

### 2.2. Cancellation Speakers in Propagation Paths

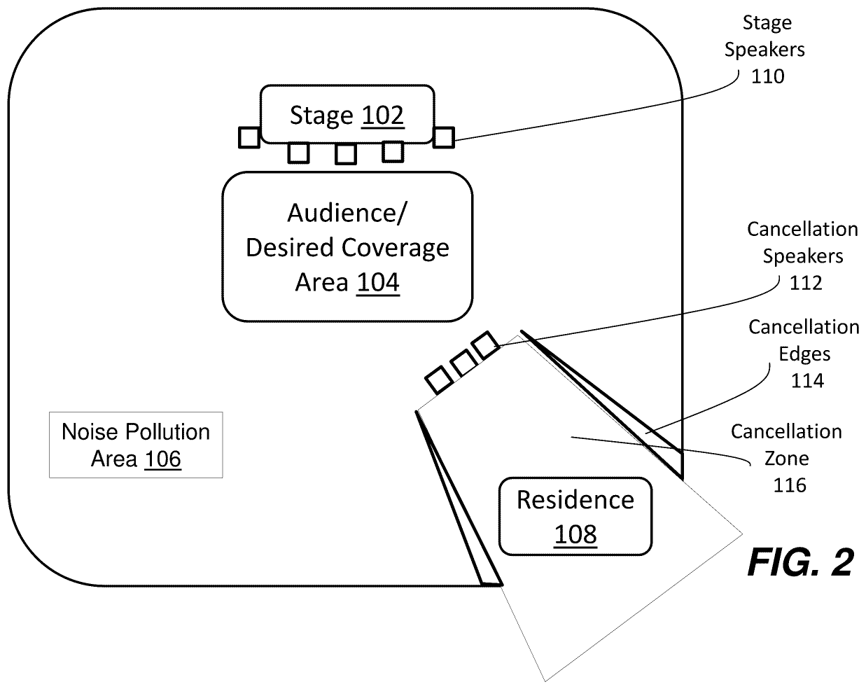

FIG. 2 illustrates example prevention of noise pollution from disturbing residents located outside a specifically designated or intended audience area 104. As shown, one or more cancellation (audio) speakers 112 can be set up with a system as described herein in sound paths from a stage 102 to a residence area 108. These cancellation speakers can be controlled by the system to generate or output a cancellation sound (wave) output, which may include relatively low frequency sounds or sound waves of opposite phases as compared with the phases of the sounds or sound waves generated by (stage or near stage) audio speakers 110 intended for the audience area 104. As a result, the relatively low frequency sounds or sound waves of opposite phased from the (stage or near stage) audio speakers 110 and the cancellation speakers 112 can cancel or attenuate each other (e.g., 50% or more reduction, below a human audible threshold for residences indoors, etc) in the residence area 108.

In some operational scenarios, relatively high and middle frequency sounds or sound waves generated by the stage speakers 110 do not travel too far outside the audience area 104. The low frequency cancellation speakers 112 can be an array of subwoofers controlled by the system to emit a cancelation or opposite (phase) audio output that matches and cancels the sounds or sound waves from the audio speakers 110 deployed with the stage 102. These (active) cancellation speakers 112 can operate under the system's control to create a white low frequency attenuation “shadow” in the direction of the residence area 108 or structures therein, thereby benefiting people in the residence structures from the (e.g., much, significantly, below an audible threshold, etc.) attenuated low frequency sounds from the stage 102.

Different frequencies of the sound waves from the stage speakers 110 and the cancellation speakers 112 may form different interference spatial patterns. For example, while these inference (spatial) patterns may include destructive interference (spatial) pattern portion(s) forming a cancellation zone 116 that cover the residence area 108, these interference (spatial) patterns may also include constructive interference (spatial) pattern portion(s) forming cancellation edges 114 or fringes around or adjacent to the cancellation zone 116.

Because of constructive interference among at least a part of the sound waves or frequency components, there is likely to be unexpected sound behavior—e.g., worsening or louder noise pollutions—at the edges or fringes of the sound cancellation “shadow”. This could result in a frequency dependent increase or decrease in volume in in the cancellation edges 114. The system can be used to ensure that specific non-audience areas such as residential areas are within the interiors of sound cancellation shadows created by the system, for example, by active cancellation using cancellation sound waves emitted by cancellation speakers or buffers. Additionally, optionally or alternatively, the system can be used to ensure that a safety margin near boundaries of around each of the specific non-audience areas is created or implemented such that edges or fringes (where constructive instead of destructive interference could occur) of sound cancellation shadows are located outside such a non-audience area and its safety margin.

The system can be used to enhance or complement preexisting audio or audio visual systems in which sound waves generated from audio speakers such as stage speakers 110 or venue speakers in general are already being transmitted over distances of air. The system can operate with cancellation speakers such as 112 of FIG. 2 to output inverse or phase opposite audio/sound waves to cancel the sound waves from the audio speakers used to cover a venue or an audience area such as 104 of FIG. 2. The cancellation speakers 112 can be set up at any sound or audio event venue to cancel or attenuate (e.g., relatively low frequency, etc.) sounds or sound waves in compliance with regulations, codes or laws of local authorities, thereby providing protection to residents and animals in (e.g., adjacent, non-audience, etc.) areas from relatively perceptually significant noise pollution.

### 2.3. Close Proximity Cancellation Speakers

In some operational scenarios, in addition to or in place of sound cancellation speakers deployed away from audio/sound/source speakers generating sound for a specifically designated area or venue such as an audience area, the system may include or operate with cancellation speakers in close physical proximity to audio/sound/source speakers. In a non-limiting example, the close proximity cancellation speakers can be used to control specific direction(s) of (e.g., relatively low frequency, etc.) sounds or sound waves from the audio/sound/source speakers. Here, the sounds or sound waves from the audio/sound/source speakers may audibly represent or depict one or more original sound sources such as one or more performers on a stage.

The audio/sound/source speakers and the close proximity cancellation speakers can create or form a speaker array. In some operational scenarios, processing respective audio signals feeding the audio/sound/source speakers and the close proximity cancellation speakers can result in the relatively low frequency sounds or sound waves only traveling in specific controlled directions.

The difference between a speaker array formed by audio/sound/source speakers and cancellation speakers in close proximity and a setup of audio/sound/source speakers and cancellation speaker in spatial separation (e.g., in FIG. 2, etc.) can be analogous to that between a lightbulb and a flashlight. More specifically, the speaker array formed by audio/sound/source speakers and cancellation speakers in close proximity produces directional sound control similar to a flashlight directing light in a specific direction. Just as the direction of light can be controlled by a user operating the flashlight, the system can control the direction of the overall sounds and sound waves by controlling respective audio outputs from the close proximity audio/sound/source speakers and cancellation speakers in the speaker array.

In comparison, in the setup of audio/sound/source speakers and cancellation speaker in spatial separation (e.g., in FIG. 2, etc.), the audio/sound/source speakers may produce the source audio sounds or sound waves in all directions, while the cancellation speakers may act or establish a (sound) barrier blocking some of the source audio sounds or sound waves produced by the audio/sound/source speakers in one or more protected areas or directions, just as a source lightbulb shining radially in all directions may be blocked a (light) barrier—or light cancellation—blocking some of the light generated by source lightbulb from illuminating one or more protected areas or directions.

### 2.4. Directional Cancellation

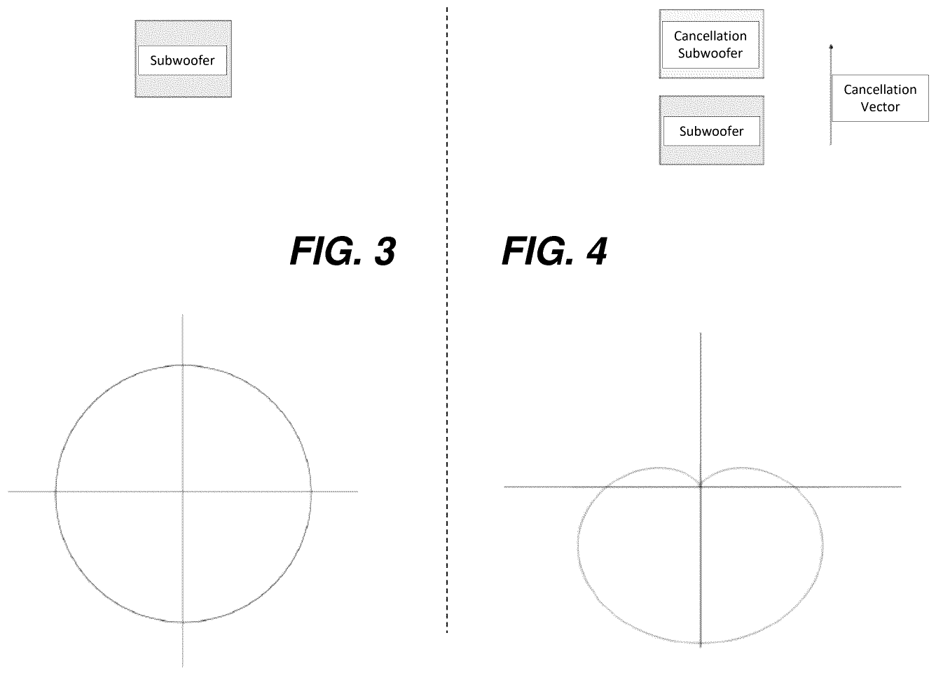

FIG. 3 illustrates an example subwoofer with a natural omnidirectional sound radiation pattern. In this example, (relatively low frequency) sounds or sound waves generated by the subwoofer can propagate equally in all directions regardless of how the speaker or subwoofer may orient. In contrast to the subwoofer, relatively high and middle frequency speakers can have specific directional sound outputs due to the shorter wavelengths and physical size of the speaker enclosures or spatial dimensions.

FIG. 4 illustrates an example speaker array of a subwoofer and cancellation subwoofer. The subwoofer may be an audio, source or sound speaker generating sound waves for an audience area or one or more specific or designated areas, whereas the cancellation subwoofer may produce sound waves to cancel or attenuate the sound waves from the subwoofer in one or more specific spatial directions. In other words, the interaction—or sound wave interference—between two subwoofers, when driven with appropriately processed or respective audio signals, can cause constructive interference (summation) in one or more first directions, and destructive interference (cancellation) in one or more second or other directions.

As shown in FIG. 4, the upper portion illustrates or corresponds to destructive interference (or cancellation) where the combined or overall sound wave amplitude from the subwoofer and cancellation subwoofer is substantially zero at the rear of the subwoofer. In contrast, the lower portion illustrates or corresponds to constructive interference (or summation) where the combined or overall sound wave amplitude from the subwoofer and cancellation subwoofer is substantially greater than that of the subwoofer alone in front of the subwoofer. This interference or cancellation pattern may be represented with a cancellation vector indicated as an arrow in a spatial direction from the subwoofer towards the cancellation subwoofer. The left and right sound wave amplitudes may also be reduced in relation to the rear reduction.

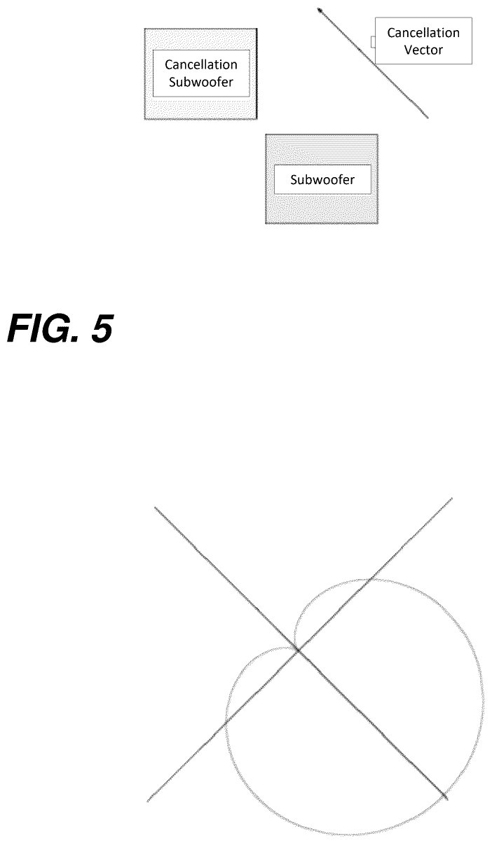

Specific directional sound cancellation can be controlled or effectuated by specific placement of cancellation speaker(s) in spatial relations to audio/sound/source speakers. As illustrated in FIG. 5, a cancellation subwoofer can be placed in a specific spatial direction such as an offset diagonally from a subwoofer. The interaction between two subwoofers, when driven with appropriately processed or respective audio signals, can generate an interference or cancellation pattern in which constructive interference (summation) is caused in one or more first spatial directions such as a first diagonal direction, and destructive interference (cancellation) is caused in one or more other or second spatial directions such as a second diagonal direction opposite to the first diagonal direction. A cancellation vector can be represented by an arrow in a diagonal direction from the acoustic center of the (primary) subwoofer towards the acoustic center of the cancellation subwoofer.

In order to cancel sounds or sound waves from a (primary or audio/sound) source subwoofer, a cancellation speaker needs to match the amplitude of the source subwoofer across some or all of its operating frequency range. Ideally, the cancellation speaker needs to create an equal and opposite spatial pressure (or inverse or opposite phase sound wave). In some operational scenarios, specifications or capabilities of the source and cancellation speakers may be matched.

In some operational scenarios, smaller speakers (e.g., with smaller amplitude or power outputs, operating with smaller frequency ranges, as compared with source speakers, etc.) may be used for rear-facing—opposite to the front directions of source speakers—cancellation speakers. There can be a sacrifice in the amount of sound wave reduction and potentially in stability of sound cancellation. For example, if a smaller cancellation speaker reaches its sound output limits before larger source speakers for which the smaller cancellation speaker is used to cancel or attenuate sound waves in specific directions, the source and cancellation sound or sound wave relationship between the source and cancellation speakers can change dynamically depending on time varying amplitudes of sounds or sound waves, which may adversely affect (the amount and stability of) sound cancellation in the specific directions.

The radiation/polar pattern inherent to a speaker may be frequency dependent. If the wavelength corresponding to a (e.g., a relatively low, etc.) frequency of sound waves being reproduced by the speaker is longer than the physical dimensions of the speaker's housing or cabinet, the sound waves will diffract around the speaker's physical housing or cabinet and travel in all directions unimpeded. Low frequency subwoofer speakers in professional audio generally have an operating frequency range of around 25-120 Hz, so the shortest wavelength corresponding to the upper limit of 120 Hz of sound waves produced by such speakers is ˜2.8 meters. Even the largest spatial dimensions of audio speakers may fall under this size; therefore, the professional audio subwoofer may be inherently omnidirectional.

In contrast, higher frequencies have or correspond to shorter wavelengths. Spatial dimensions of physical housings or cabinets of speakers used to generate relatively high frequencies of sound waves may be comparable to or larger or much larger than relatively small wavelengths corresponding to the relatively high frequencies. As a result, these speakers tend to be naturally directional, as frequency of sound waves generated by these speakers increases. In an example, a medium frequency range of sound waves can be around 120-2,000 Hz with the shortest wavelength ˜35 centimeters, which may be comparable to or smaller than the spatial dimensions of speakers generating the sound waves. In another example, a high frequency range of sound waves can be around 2,000 to 20,000 Hz with the shortest wavelength ˜1.7 centimeters, which may be much smaller than the spatial dimensions of speakers generating the sound waves. Because these higher frequencies reproduced by the high and medium frequency range speakers are longer than the spatial dimensions of the speakers'physical housings or cabinets, the sound waves will not diffract around the speakers'physical housings or cabinets and will travel in the directions of the speaker cones.

The polarity of a signal describes whether a positive input signal will produce a positive output with the associated speaker cone moving outward or if a positive input signal will produce a negative output with the associated speaker cone moving inward. The phase of a (sound) wave describes the position of the wave within a frequency cycle at a given point in time. Sound cancellation relies on being able to time align two sound sources (e.g., a source speaker and a cancellation speaker, etc.) such that the frequency and magnitude of sound waves being output are matched, but the polarities or phases of the sound waves are inverted. When two sound waves of the same frequency and amplitude are 180 degrees out of phase in which one of the sound waves is the inverse of the other sound wave, the two sound waves cancel each other out, resulting in no net sound. In many real world operational scenarios, (inverse) alignment between source and cancellation sound waves may not be exact due to external factors, such as air being a turbulent medium, introducing errors. The close proximity of the source and cancellation sound sources or speakers can help minimize these errors, leading to significantly reduced sound signals.

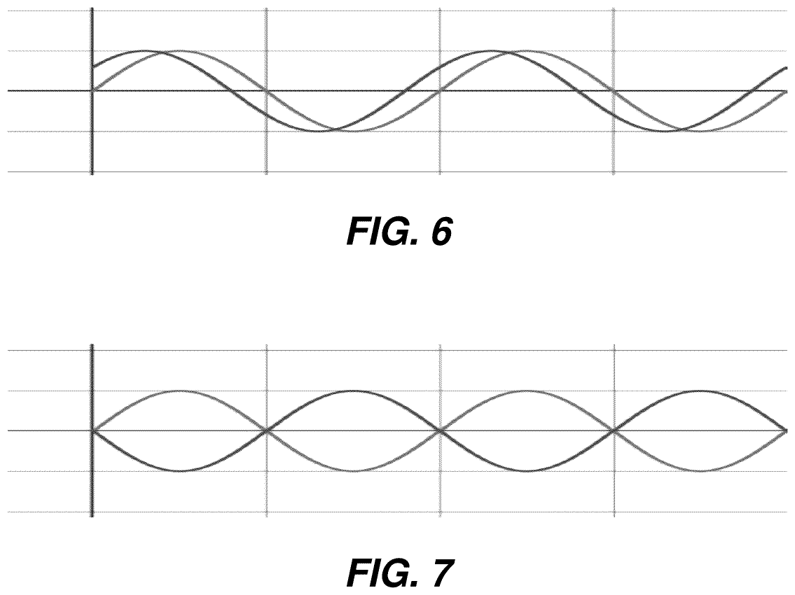

FIG. 6 illustrates a first example graph having two sound waves generated by two different speakers. The X-axis represents time, whereas the Y-axis represents sound wave displacement or spatial pressure up to a specific amplitude as its maximum. While the two sound waves have the matching amplitude with different phases, the sound waves or their phases do not have the exact inverse relationship. As a result, these two sound waves do not cancel each other out but rather produce a net sound output.

FIG. 7 illustrates a second example graph having two sound waves generated by two different speakers. In comparison with FIG. 6, the two sound waves in FIG. 7 have the matching amplitude with different phases that have the exact inverse relationship. As a result, these two sound waves effectively cancel each other out and produce a net zero sound output.

The system as described herein can include or operate with source or primary speakers and cancellation speakers that are specifically time aligned to generate sound waves of the same or similar magnitude but with opposite phases or polarities in specific spatial areas or directions to cancel or attenuate overall sound waves in these specific spatial areas or directions. The specific time alignment can be effectuated by physically arranging or moving the speakers in space or by delaying audio signals being input to—or being used to drive—the speakers. Specific time alignments are inherently easier to implement for sound waves of relatively low frequencies as they correspond to relatively long wavelengths providing relatively great margin for error in achieving the specific time alignment. In other words, small timing differences have little impact on phase relationships for sound waves of relatively low frequencies compared with sound waves of relatively high frequencies corresponding to relatively short wavelengths.

For the purpose of illustration only, it has been described that the system can implement sound cancellation for relatively low frequencies. It should be noted, however, that in various operational scenarios, the same cancellation theory or operations can be implemented with the system to apply to some or all frequencies audible to the human auditory system. In some operational scenarios, the system can include, integrate or operate with relatively high and medium frequency sound cancellation speakers to achieve sound cancellation with respect to relatively high and medium frequency sounds or sound waves, similar to those described for the relatively low frequency sound cancellation. For example, separate relatively high and mid frequency cancellation speaker cabinets can be placed behind source high/mid speaker units to create cardioid dispersion or directional sound cancellation in the low mid frequencies of the frequency ranges of the source speaker units in the exact or similar manner how subwoofer arrays can be used to create cardioid dispersion or directional sound cancellation for relatively low frequencies. Additionally, optionally or alternatively, the system can include or integrate or operate with relatively high and mid frequency cancellation speaker configurations that are optimized for directional sound cancellation in computer sound simulations or modeling and/or real world testing applications/operations.

The smaller wavelengths corresponding to the high and mid frequency sound waves mean that physical positioning and time alignment are crucial or important to achieve relatively high accuracy. Under other approaches, the cost to achieve effective directional sound cancellation for an audio event or venue may be relatively high with a relatively large amount of manual input or intervention from experiences sound engineers, especially on relatively strict time schedules. In contrast, the system as described herein can obtain audio or non-audio measurements automatically with physical sensors around a venue. The system can also automate subsequent creation of audio or digital signal processing settings with optimized operational parameters to handle or perform (e.g., speaker specific, directional specific, frequency specific, etc.) fine grained tuning to make high, midrange, and low cancellation speaker configurations viable.

### 2.5. Sound Control System

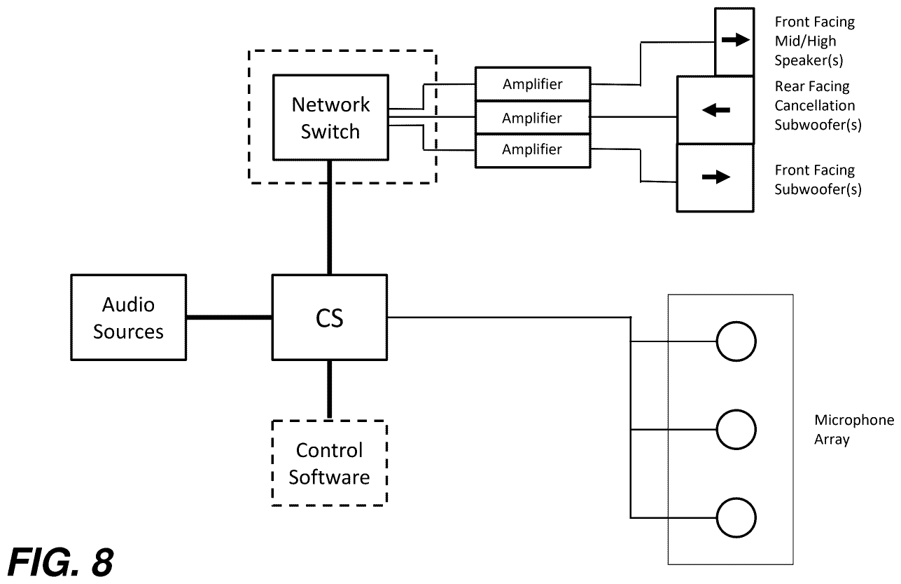

FIG. 8 illustrates an example control system for a relatively simple sound system with directional noise reduction/cancellation controls that can emit sound (or sound waves) in a forward spatial direction but prevent, reduce or cancel relatively low frequency sound (or sound waves) from being emitted in a reverse or rear spatial direction.

An audio source (e.g., a mixing desk, an MP3 player, a performer's microphone, etc.) can feed an audio signal (e.g., a source audio signal, etc.) to a contained sound (CS) processor. The CS processor can run installed/downloaded control software to generate and output audio signals to an audio network switch. Whereas the audio signal fed to the CS processor represent a source audio signal, the audio (output) signals generated and outputted by the CS processor represent audio speaker signals to be amplified and used to drive audio speakers including primary source speakers and cancellation speakers.

Relatively high and middle frequency audio signals from the CS processor are amplified by corresponding relatively high and middle frequency amplifiers to drive front facing relatively high and middle frequency speakers. Relatively low frequency signals from the CS processor are amplified by corresponding relatively low frequency source and cancellation amplifiers. The low frequency source amplifiers can drive forward facing subwoofers while the low frequency cancellation amplifiers can drive rear facing cancellation subwoofers. This subwoofer speaker configuration can be similar to the subwoofer system/configuration illustrated in FIG. 4.

A microphone array can be placed at different spatial locations in or near a venue or audience area or distributed around an audio speaker system including but not necessarily limited to the illustrated speakers and subwoofers to monitor sound dispersion and sound outputs of the speakers and/or subwoofers. Some or all of the audio signals generated by the microphone array or microphones therein can be fed back to the CS processor.

Some or all of the microphones may be local microphones that are deployed in audience area(s) to monitor sound quality, sound levels, sound frequency compositions, etc., in reproduced sound generated in an audio event at the venue. Some or all of the microphones may be remote microphones that are deployed along the perimeter or the boundaries of one or more non-audience areas such as nearby residential areas or residence houses that could have issues with off-site noise pollution from reproduced sound generated in the audio event at the venue.

Adjustments to the audio (output) signals from the CS processor can be made based on this microphone array feedback. During automated measurements (e.g., before or concurrent with an audio event, etc.), the CS processor (unit) can output test tones to each speaker individually (e.g., sequentially, serially, consecutively, at least in part in parallel, at least in part concurrently, etc.), and then analyze recorded or measured responses of each speaker to ascertain, determine or select specific (audio) signal processing to achieve destructive interference (cancellation) in specific areas or directions outside the audience area. The CS processor can operate dynamically and make corresponding adjustments during system testing as well as during the audio event or performance at the venue.

Hence, physical sensors including but not limited to arrays of microphones can provide the system dynamic abilities to continuously generate and/or collect sensor measurements or sensor data in real time. The sensor measurements or data can be analyzed (e.g., used in real-time simulation/modeling with AI/ML based or non-AI/ML based techniques, etc.) in real time to continuously monitor sound levels in one or more of reproduced sound, ambient sound, sound generated from external sources, noise pollution or spatial dispersion of reproduced sound beyond the audience area(s), etc.) as well as non-audio-specific environmental data or conditions (e.g., temperature, wind, humidity, image of crowd sizes and locations in an audience area, etc.) of the venue. The dynamic capabilities can be supported or provided by the physical sensors of one or more different types—operating in conjunction with the system—deployed around different spatial locations of the venue and its surrounding environment.

Real time environmental information or data of audio or non-audio types can be collected by the physical sensors and/or data sources accessible to the system. The environmental information or data collected or analyzed by the system by way of the physical sensors and/or accessible data sources may include, but are not necessarily limited to only, any, some or all of: elevation data, meteorological data such as temperature and humidity, geography data of the venue and its surroundings, time- or location-specific sound propagation speed, time- or location-specific sound propagation range, etc.

Non-audio physical sensors such as cameras or image sensors may be used to monitor crowd dispersions around the venue. Images generated by the cameras or sensors can be used by the system to determine and adapted to listener location in real time, and to reduce sound levels where there is no listeners (e.g., turn off certain speakers at the back in the venue or outdoor music festival when a relatively small crowd is only located near the stage, etc.), or optimize the audio for the listeners'actual position or positions. On the other hand, if it is determined in real time operations from the sensor based monitoring that the crowd has become larger, the system can for example dynamically activate additional speakers or increase the sound levels of the reproduced sound in spatial locations where the audience are actually located, or dynamically adapt any DSP settings to alter any electronic steering or array settings to improve audience coverage.

Sensor based dynamic adjustments can be performed by the system autonomously or automatically with no or little human input. As a result, the system can operate with a relatively high precision, performance, and energy saving or efficiency, at a relatively low operational cost. For example, under techniques as described herein, there is little or no need to have human operators walking around the venue to monitor crowd dispersion and sound levels at various spatial locations, or to manually identify speakers to be adjusted, activated or turned off.

### 2.6. Signal Processing And Monitoring

A transfer function may be measured/determined that represents the system's behavior in the frequency domain. The transfer function describes how each audio frequency component of an input audio signal is modified to produce a corresponding output audio signal. The transfer function can be obtained by performing a Fourier transform on a system's impulse response, which is an equivalent representation of the system's behavior in the time domain.

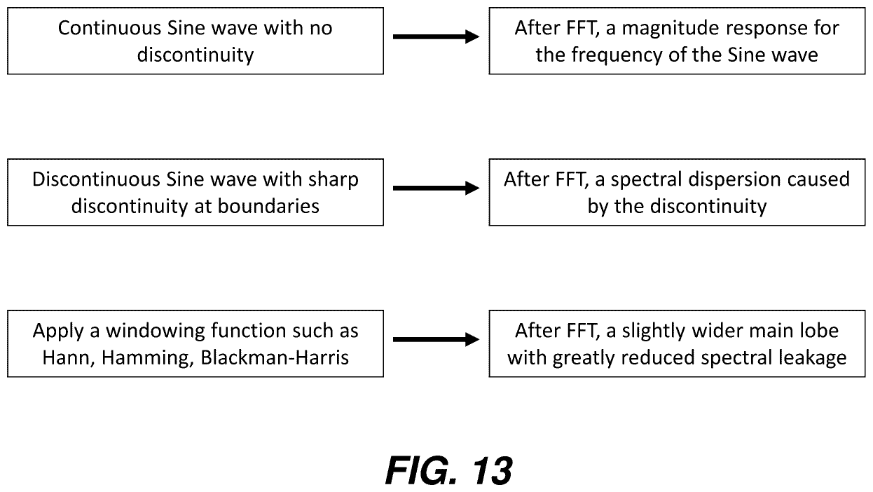

FIG. 13 illustrates example application of window functions. In signal processing, a window (function) is a (e.g., predefined, pre-specified, etc.) function that typically has relatively high values of one or up to one for a specific period of time representing a subset duration of a time window and tapers off on either side of that specific period or subset duration in the time window. When a signal is multiplied by the window function, the signal passes through at full or near full strength during the specific period of time or the central portion of the time window and gradually (e.g., continuously, differentiable and continuously, etc.) fades as it moves toward the edges of the time window; hence, the signal after multiplying with the window function may fade up to full volume/strength and then fade out again. A rectangular window (function) maintains a constant value of one throughout its duration, while another window (function), such as the Hann, Hamming, or Blackman-Harris window, may shape the signal and taper off smoothly.

When or after performing an FFT (Fast Fourier Transform) on a sample portion (e.g., in a finite time duration, in a time window, with some or all past values in the time domain, etc.) of a signal, the mathematical function implementing the FFT assumes that this sample repeats infinitely in both time or temporal directions. This assumption treats the signal as if it continues seamlessly at the boundaries of the sample (or time window occupied by the sample), even if the signal actually does not. Hence, if this assumption holds true, such as in the case of the signal being a continuous Sine wave with no discontinuity, the FFT will generate a single magnitude response for the frequency of the Sine wave, as illustrated in FIG. 13.

On the other hand, if the signal does not actually or naturally repeat, discontinuities can occur at the boundaries, such as in the case of the signal being a discontinuous Sine wave with sharp discontinuity at boundaries. The FFT will introduce errors known as spectral leakage or dispersion in magnitude responses, as illustrated in FIG. 13. This spectral leakage or dispersion causes (signal) energy to spread across multiple frequency bins, for example around the frequency of the Sine wave, rather than being confined to the true frequency components of the signal such as the frequency of the Sine wave in the present example.

Windowing—or applying or multiplying the signal with a selected window function—helps reduce this error (spectral dispersion or leakage) by tapering the signal to minimize these boundary discontinuities, thereby generating a slightly wider main lobe in magnitude response with relatively significant or greatly reduced spectral dispersion or leakage, as illustrated in FIG. 13. Different window (or windowing) functions have various advantages and disadvantages, and the choice or selection of a specific window or windowing function may be based on specific factors associated with a specific (e.g., audio, video, signal processing, etc.) application.

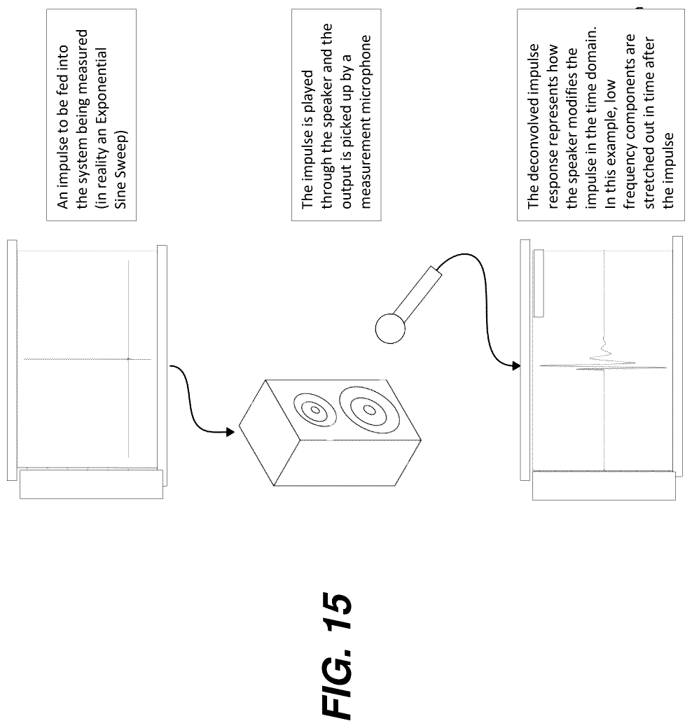

FIG. 15 illustrates an example process flow in an impulse response generation process or method. In some operational scenarios, specific windowing (or application of specific window or windowing function) can be performed or applied to an impulse response (e.g., generated by the process flow of FIG. 15, etc.) to reduce effects of any error such as background noise or reverberation in a measurement environment in which the system operates.

A (e.g., specifically programmed, etc.) computing device can be used to measure the impulse responses from some or all speakers with which the system operates and calculate differences between a currently measured impulse response (e.g., of an audio signal generated by a specific speaker at a specific spatial location as measured in the same or a different spatial location in the venue, etc.) and a target impulse response to be realized or implemented in the same venue.

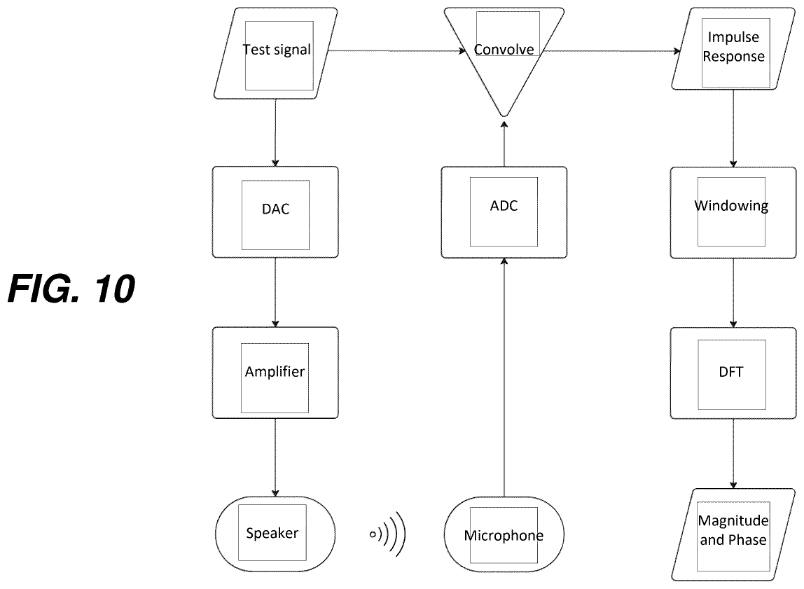

FIG. 10 illustrates an example process flow for measuring magnitude and phase responses of an audio speaker or loudspeaker. The system as described herein can generate an original test signal which is played through the audio systems operating with the system including but not limited to the audio speaker loudspeaker, via a Digital to Analog Converter (DAC) feeding and amplifier.

The output of the speaker or loudspeaker is received by an audio input device such as a microphone, which feeds back into the system via an Analog to Digital Converter (ADC). The system can then convolve the output of the speaker or loudspeaker with the original test signal to retrieve or determine the speaker or loudspeaker's impulse response (IR).

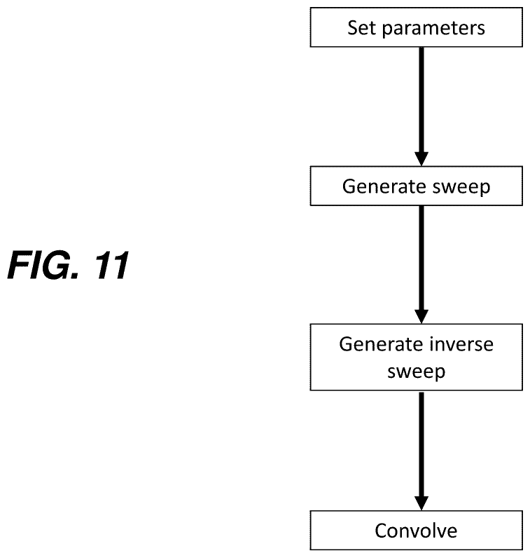

In some operational scenarios, as illustrated in FIG. 11, the original test signal may represent an exponential Sine sweep (ESS). Operational parameters for generating the original ESS test signal may be first set by the system. Examples of the operational parameters for the ESS may be duration(s), start and end frequencies (in Hz), sampling rate, etc. Based at least in part on the operational parameters, the system can generate the ESS test signal used to derive an audio speaker driving signal via the DAC and amplifier to drive the speaker or loudspeaker to generate the output of the speaker or loudspeaker. In addition, an inverse sweep corresponding to the ESS may be generated by the system and used to convolve with a measurement signal, as generated with the microphone and the ADC from the output of the speaker or loudspeaker, to derive the speaker or loudspeaker's impulse response (IR).

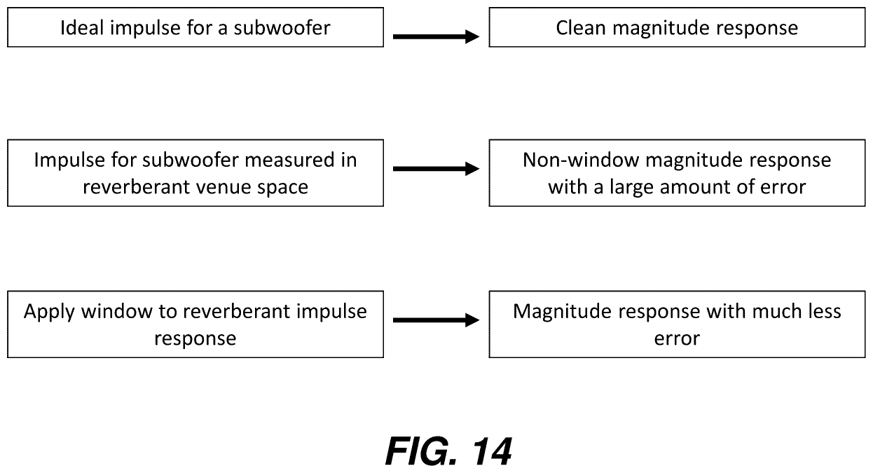

Referring back to FIG. 10, the speaker or loudspeaker's impulse response is a time-domain representation of the system's behavior (in connection with the speaker or loudspeaker and related audio processing operations) in terms of amplitude and phase across all frequencies. The impulse response may contain errors in the form of background noise or reverberation from the measurement environment. To reduce the contribution of these errors, windowing (e.g., as illustrated in FIG. 14, etc.) may be performed to generate corresponding windowed IR, which can then be converted from the time domain into the frequency domain using a Discrete Fourier Transform (DFT) to recover the speaker or loudspeaker's transfer response (or function) in the frequency domain. The transfer response provides a frequency domain representation of the speaker or loudspeaker's magnitude (or amplitude) and phase in a range of frequencies.

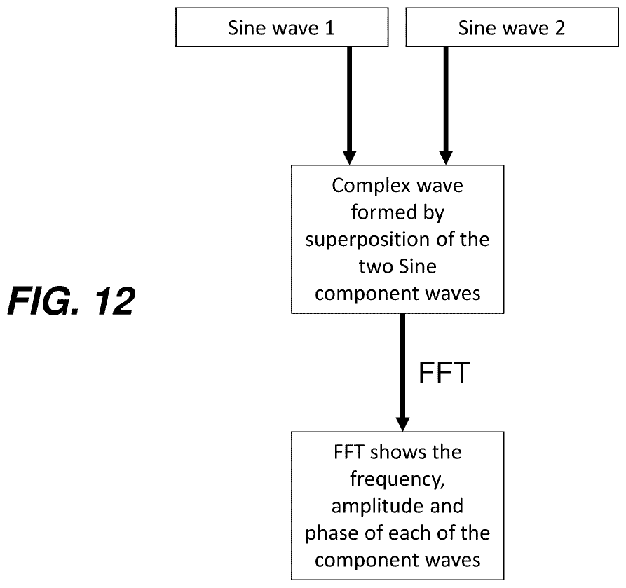

As noted, the system can use the impulse response in the time domain to determine the corresponding transfer function(s) in the frequency domain using a Fourier transform process or a Fast Fourier Transform (FFT) as illustrated in FIG. 12. Fourier's theorem states that any period signal can be represented as a sum of sine and cosine waves, with specific frequencies, amplitudes and phases. The Fourier transform represents a mathematical operation that decomposes a signal such as a complex signal (e.g., formed by superposition from two Sine waves 1 and 2 of two different frequencies as shown in FIG. 12, etc.), into its sine and cosine components (e.g., two Sine components respectively corresponding to the two different frequencies in the present example of FIG. 12, etc.). FFT can take a time-varying signal, like a sound wave, and generate or provide corresponding amplitudes and phases of all the frequencies that make up the sound or time-varying signal. This process transforms the time-varying signal from the time domain to the frequency domain. In digital signal processing, the Fast Fourier Transform (FFT) can be efficiently implemented or performed to compute the Fourier transform. Based on the FFT conversion, the system as described herein can determine, generate or produce transfer functions for the audio system including but not limited to speakers operating therewith.

FIG. 14 illustrates example IR windowing operations. As shown at the top of FIG. 14, an ideal impulse response in the time domain may be obtained for a subwoofer (e.g., d&b Y-Sub subwoofer, etc.) measured in an anechoic space. This ideal impulse response in the time domain may be transformed (e.g., FFT, etc.) into the frequency domain, yielding a clean magnitude response. On the other hand, a different (e.g., non-ideal, etc.) impulse response in the time domain may be obtained for the same subwoofer measured in a reverberant or noisy space. This non-ideal impulse response in the time domain may be transformed (e.g., FFT, etc.) into the frequency domain, yielding a magnitude response that shows a relatively large amount of errors compared to the clean magnitude response from the anechroic measurement. After applying a window or windowing function to the non-ideal impulse response in the time domain, the windowed impulse response in the time domain may be transformed (e.g., FFT, etc.) into the frequency domain yielding a magnitude response that shows a relatively small amount of error (e.g., at the expense of some low frequency resolution, etc.).

### 2.7. Energy Efficiency And Power Conservation

The system as described herein can be designed and implemented with notable consideration for energy efficiency. In an example, by prioritizing relatively high fidelity in sound reproduction, listener expectations can be met at relatively low sound levels which, in turn, contributes to a reduction in energy use. In another example, by leveraging psychoacoustic effect processing to create an illusion of relatively low frequency reproduction (but actually absent in) in the reproduced sound to the human auditory system, energy consumption or usage that would be otherwise incurred to actually reproduce these low frequencies in the reproduced sound can be saved.

The system may incur additional energy usage for enhancing specific capabilities such as sound containment. For example, the system can use additional amplified sound reproduction components (e.g., cancellation speakers or subwoofers, etc.) for the purpose of controlling sound propagation.

In many operational scenarios or contexts, the system can still deliver overall energy savings. For example, sound containment may be more or less important at different times of the day, and the perceivable effect of psychoacoustic processing can have a greater or lesser impact on different types of audio content. The system may deprioritize or even disable certain effects, such as sound containment, in favor of energy efficiency as an operational objective in some operational scenarios. The system can perform autonomous (e.g., automatic, with no or little user input or intervention, etc.) dynamic adjustment of its operational configuration in response to real-time (e.g., sensor, microphone, etc.) measurements of sound output in an environment or venue to ensure that the system does not waste energy in service of producing audio related effects which might not be effective or needed. The overall energy efficiency and savings of the system in its deployment and operations can (e.g., significantly, measurably, etc.) lower operational costs.

### 2.8. Operational Control

The system may implement an initial configuration determined, developed or specified based at least in part on a predefined model of a sound reproduction system in a given (e.g., spatial, physical, etc.) environment or venue. The predefined model may include or incorporate data or information relating to a physical layout of sound reproduction system components (e.g., audio sources, audio network switches, amplifiers, speakers, signal processors, microphones, etc.) including but not limited to signal processing components used to monitor sound reproduction and pollution in real time. The predefined model may include a target magnitude curve across a predefined listening or audience area in the environment or venue.

The predefined model may be modified, if needed, to achieve or conform to operational constraints defined for an initial operational context. The system can start or perform autonomous operational parameter (or constraint) adjustments in response to real-time (e.g., sensor generated, microphone generated, signal processor generated, etc.) environmental measurements or data, for example to avoid or minimize variance in a resulting (e.g., actual, etc.) output in relation to a target or intended output corresponding to the initial operational context or the initial configuration. Hence, in response to real time context changes as measured or determined from the real-time environment measurements or data, the system can autonomously (e.g., with no or little user input or intervention, etc.) modify its configuration to maintain conformance to the adjusted operational parameters and/or constraints.

The system can be configured or implemented to control a relatively large number of operational parameters relating to operating system components or devices to achieve intended or specified results for audio reproduction in the environment and venue. The numerosity of these operational parameters makes it infeasible, unusable or unsafe in many operational scenarios to provide manual control of individual settings whose values may need to be continuously recalculated or implemented in real time operations as part of an interdependent configuration, in which different system components or devices operating with the system may be dependent on one another that may or may not be obvious or discernable by human operators in the real time operations.

The system can be implemented or used to provide relatively abstracted (e.g., streamlined, simplified, etc.) controls designed to facilitate translation of a designated user or an operator's intention or input, which may represent or specify a desired or intended effect in the sound reproduction in the environment and venue.

For example, the user or operator may wish to raise the maximum perceived level in reproduced sound generated by the system (along with included or attendant audio reproduction systems devices operating with the system) by 6 dB. This might be thought of as a relatively simple operation, but in fact in a system configured to provide sound containment and conformance to operational parameters or constraints defined by an operational context, effectuating such a change may be relatively complex.

Under other approaches, abrupt (system or component) reconfiguration of numerous operational parameters for a relatively large number of audio processing and reproduction systems or components such as sound system components, for example through simple interpolation of control parameter values, can serve to damage some or all of these sound system components, generate perceptible audio artifacts, and even harm listeners with negative user experience.

In comparison, the system as described herein can be implemented or used to provide relatively smooth transitions between different configurations in real time operations with little or no user input or intervention while maintaining conformity. The system implements and leverages its (e.g., real time, non-real-time, etc.) modeling capabilities to ensure that reconfiguration of sound system components operating with the system is performed safely to the system and listeners as well as achieving the desired or intended effect specified with minimized or relatively simple user or operator input (e.g., raise 6 db, etc.).

### 2.9. AI and ML Enabled Operations

The system may be implemented to include or employ artificial intelligence (AI) and/or machine learning (ML) processes and models. For example, these AI and/or ML may be used to support natural language processing (NLP) to process natural language based user or operator input or prompt as well as generate natural language output to users and/or operators. These AI and/or ML may be used by the system to help enable new capabilities or enhance existing capabilities relating to audio processing, audio reproduction, sound containment, non-real-time initial configuration, real time reconfiguration, real time monitoring, etc.

The AI and/or ML (prediction) models may be trained, pre-trained or optimized in a (model) training phase with training datasets that include training data instances. Some or all of the training data instances may be automatically generated, collected, archived, and/or human annotated or curated. The training data instances may include different instances of past system configurations (e.g., audio processing systems, devices or components, speakers, loudspeakers, subwoofers, cancellation speakers or subwoofers, etc.), past venue/environment descriptive data (e.g., topography, audience area, residential area, buildings, sound barriers, etc.), past real time sensor or microphone measurements and data relating to various venues/environments and/or audio processing and/or sound reproduction systems/components/devices, past real time reconfigurations of operational parameters or constraints, etc.

In some operational scenarios, in the model the trained, pre-trained or optimized AI and/or ML prediction models can be used in a (model) application/inference phase by the system to enable autonomous operational parameter or constraint control. This helps remove much need for continuous human or highly skilled specialist supervision in many if not all operational scenarios. NLP capabilities of these AL and/or ML models operating with the system can be used to provide or support relatively intuitive or simple user interface or system control operations for both skilled and unskilled users or operators.

These AI and/or ML models can be used by the system to improve the system's performance—not only with respect to sound reproduction, but also in the system's ability to successfully and reliably interpret operator intent expressed in natural language input or prompt and convey feedback relating to audio processing and/or sound reproduction (including but not limited to sound containment, etc.) operations. For example, natural language instructions (or inputs/prompts) may be received from a user by a natural language processor operating with the system. The natural language instructions from the user may be relatively high level such as “aim number 2 audio cancellation speaker array in a 30 degree angle from an axis line in a venue.” The natural language instructions may be interpreted by the system by way of a natural language processor. The system can work out all or some adjustments or settings of operational parameters of audio processing and/or rendering devices or components to carry out the user's natural language instructions such as beaming sound waves from the specific audio cancellation speaker array in the specific direction instructed.

In many operational scenarios, the use or operation of sound reproduction systems operating with the system may concern a variety of stakeholders or human users with a range of responsibilities and levels of authority. The stakeholders'interests may or may not be aligned. These users can provide input in the form of natural language instructions (or inputs/prompts). Different users'inputs may be prioritized differently and may be assigned with different individual weights. Examples of such stakeholders may include, but are not necessarily limited to only: venue and equipment owners, event promoters, engineers, technicians, patrons, special guests, local authorities, first responders, etc. Some or all of these stakeholders may expect their concerns or inputs regarding the sound reproduction systems or reproduced sound at a venue to be considered the highest priority.

For example, the sound engineer may prefer a higher volume in the audience area, and the audience might also desire louder sound. However, the bar manager may request lower volume levels in the bar. Under other approaches that do not implement techniques as described herein, this situation would typically be addressed by either increasing or decreasing the overall system volume. Under techniques as described herein, relatively fine granular control—such as removing relatively low end sound content portions and increasing psychoacoustic loudness of relatively important sound content portions—may be performed over some or all of individual system elements in the system based on user inputs (which may be in the form of natural language inputs or prompts), thereby Increasing the quality and/or loudness perception of sound on site or in the audience area(s) and decreasing the volume of sound off site in the non-audience areas. In addition, the system can reconcile the different user inputs that are in conflict based on respective priorities or weights assigned to these user inputs.

The system can be implemented with AI/ML and/or non-AI/ML models or processes to provide support for managing inputs or interests of diverse stakeholders. Access to different aspects of the system's functionality may be limited to according to customizable (e.g., stakeholder specific, etc.) rules. The relatively powerful signal processing capabilities of the system can be used to produce localized changes in audio or sound output to satisfy specific concerns.

### 2.10. Example System or Platform Functions

The system can be used to implement, provide or support a platform for performing a range of desirable or target system functions (e.g., design, measurement, tuning, etc.) in connection with sound reproduction and/or containment in a physical environment or venue.

This platform can be used to automate design, simulation and subsequent measurement and alignment of (e.g., functionally, spatially, etc.) distributed sound systems operating with the system, and to automatically configure the distributed sound systems to implement or optimize sound containment or rejection in arbitrarily defined spatial areas, locations or zones in reference to specific audience areas, locations or zones for sound reproduction. The spatial areas, locations or zones for sound containment and reproduction may be specified or adjusted in operations by designated users or operators operating the system or platform.

Source audio signals (e.g. from an audio mixer, a DJ setup, etc.) can be ingested or received as input by the platform or system. The platform can apply audio or digital signal processing (DSP), distribute processed audio or audio signals to various audio output devices such as audio network switches or amplifiers to drive individual speakers or loudspeakers or groups of loudspeakers. The system can receive or measure audio sound by way of microphones deployed at various spatial locations in the venue and connected with the system to measure individual and/or overall performance of the speakers or loudspeakers.

Interactions with designated users or operators may be supported via user interface and/or natural language processing implemented by the platform or system to allow the users or operators to create a spatial model of the space or venue. In an example, the spatial model of the space or venue may be imported into or received/established by the system based on one or more of: a computer aided design (CAD) model, manual entry or user input, collected (e.g., sensor generated, etc.) photogrammetry data, collected (e.g., sensor generated, etc.) light detection and ranging (LIDAR) mapping data, collected (e.g., sensor generated, etc.) structured light scanning data, collected (e.g., sensor generated, etc.) time-of-flight sensing data, collected (e.g., sensor generated, etc.) simultaneous localization and mapping (SLAM) data, or data collected or generated by other applicable processes or data sources for capturing and generating 3D models for a room, building, arena, space, or venue, etc.

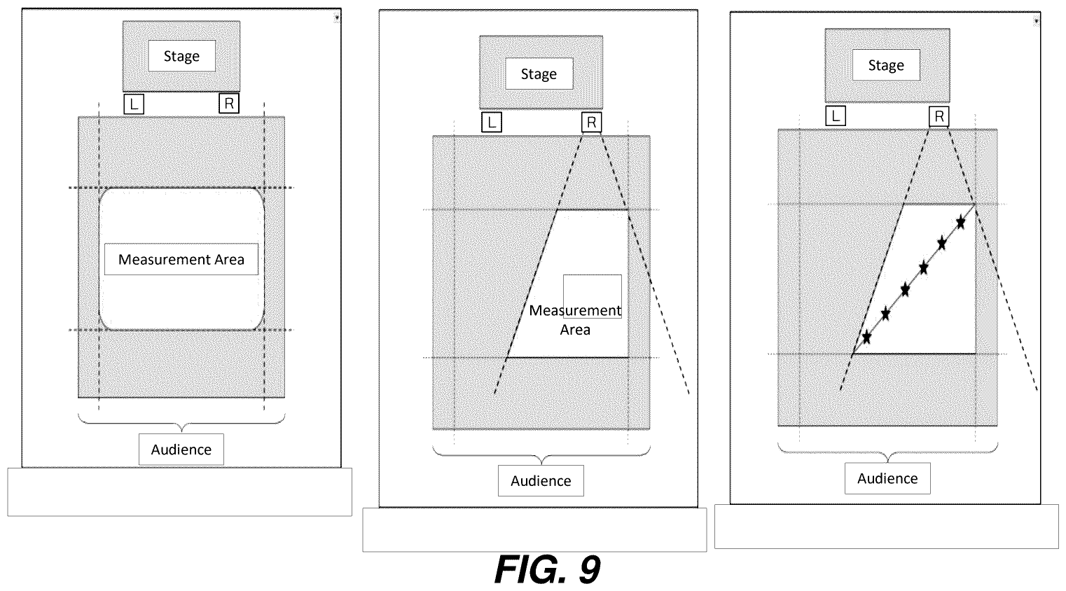

FIG. 9 illustrates example determination of a model of a venue such as stage, audience area, measurement area or positions, etc. A user may be enabled by the system or platform to (e.g., freely, etc.) define or specify audience and stage areas, as well as areas and points where speakers and/or microphones and/or other non-audio sensors are to be positioned. As illustrated, based at least in part on user input, the system can first establish a measurement area of the venue. The system can also establish a position of an individual speaker such as a left or right speaker and a specific measurement area corresponding to the individual speaker. Within the specific measurement area for the individual speaker, the system can further establish specific measurement locations automatically or at least in part based on the user input.

In some operational scenarios, the user can interact with the platform or system to specify an inventory of available equipment including but not necessarily limited to only: speakers, amplifiers, rigging hardware, etc.

The platform or system can generate a speaker layout, as well as predicted audio or digital signal processing (e.g., thresholds, constraints, other operational parameters, etc.) settings that can include level offsets, delay times, infinite impulse response (IIR) filters, finite impulse response (FIR) filters, polarity inversion, dynamics processing, and so on, for the purpose of achieving or realizing as close as possible to a desired or target audio output coverage pattern over the venue (e.g., including vicinity or surrounding areas other than the intended or specified audience area, etc.).

Various (e.g., static, dynamic, real time, non-real-time, etc.) visualizations such as simulations of the predicted audio output coverage pattern, predicted impulse responses at various listening positions, standard deviation or other measures of errors in levels at various frequencies, etc., can be presented or rendered, to the user, by the platform or system on image display(s) for viewing, monitoring, interaction purposes.

Once a speaker system for sound production and/or containment is deployed as per the selected or target design for the venue, the user can interact with the platform or system to be directed to specific spatial locations to place measurement microphones and/or other non-audio sensors. The microphones and/or sensors can be connected or communicatively coupled to the platform or system, which can run automated tests such as sending test signals (e.g., ESS, etc.) through each speaker and recording a corresponding audio or sound output generated by the speaker to verify and ascertain a specific or target initial performance of the system.

The platform or system can process, aggregate, average or analyze multiple measurements from one or more microphones or sensors and/or increase signal-to-noise ratios of its measurements. In some operational scenarios, AI/ML-based techniques or pretrained models may be implemented or included in the platform or system for noise reduction in reproduced sound by speakers or loudspeakers or subwoofers, as audibly perceived by the intended audience in the venue.

Some or all of the individual systems, components, devices, elements of the overall system, including but not limited to phase and/or magnitude alignment between different audio processing or reproduction or cancellation elements, can be calibrated with the platform or system to ensure or realize target or specific summation (effects) in specific spatial areas, zones, locations, positions or spatial directions in which intended audience is located, as well as to ensure or realize target or maximum cancellation (effects) in other specific spatial areas, zones, locations, positions or spatial directions, as assigned by designated user(s) or as determined/identified based on specific user input. Hence, the system can minimize off site disturbances and maximize user enjoyment or experience on site using automatic or autonomous sound reproduction and/or containment augmentation active processes or operations in real time.

The platform can operate to compare real time collected real-world measurements collected from microphones or other sensors or devices and/or analytical results of the collected measurements with specific predicted target values and modify audio or digital signal processing settings accordingly to account for discrepancies or errors in (e.g., before the event, earlier, etc.) simulations, thereby further optimizing the performance of sound reproduction systems operating with the system such as speaker arrays. The system can invoke, continue in, or repeat, a cycle of measuring and updating/optimizing these settings until specific desired or target results or effects are achieved in sound reproduction and/or containment/cancellation.

A computer stored or maintained “digital twin” (or operational profile) of the sound reproduction systems and encompassing space around the venue, including specific contents and patrons may be generated with the platform or system. This digital twin may be used by the platform to compare with what the sound reproduction systems actually produce in sound reproduction and/or containment/cancellation as measured by the microphones and sensors. The difference between the actual reproduced sound and specific targeted reproduced sound as specified with the “digital twin” can be used to adapt some or all audio related operations—of the sound reproduction systems as well as interoperating devices and components—in real-time to the dynamically changing environment at the venue.

The platform or system can perform operations relating to harmonic synthesis and the missing fundamental phenomenon for the purpose of reducing or eliminating energies of relatively low frequencies in the reproduced sound, resulting in less noise propagation and reduced energy/power consumption than otherwise.

One or more decorrelation techniques in a range of decorrelation techniques can be used or implemented by the platform or system to reduce unwanted interaction between sound (reproduction and/or cancellation) system elements that could otherwise cause unintended cancellations within the listening space such as in the audience area.

In some operational scenarios, microphones and sensors can operate with the platform or system to pick up (or detect/monitor) and analyze sound emanating from third party sources (e.g., another PA or sound reproduction system not a part of the system or platform, etc.). The platform or system can create an inverse noise cancellation signal through speakers or devices operating with the system to reduce or cancel noise pollution. For example, the platform or system may implement or perform beam-forming, wave field synthesis or related techniques to recreate matching wavefronts to those emanating from detected third party sound sources so that matching but inverted signal or sound waves can be created to cancel noise pollution.

The platform or system may (e.g., wirelessly, optically, electrically, etc.) connect to remote microphones positioned at spatial points/locations/positions/areas/directions at which sound pollution from the sound reproduction systems operating with the system has been identified or deemed as a (e.g., likely, probable, certain, potential, predicted, etc.) problem, such as neighboring property boundaries. The platform or system can adaptively filter problem frequencies or adapt audio related processing to focus or generate cancellation sound waves along cancellation direction(s) with selected center frequencies in real-time.

### 2.11. Autonomous Mitigation of Partial System Failure

In some operational scenarios, a (e.g., stereo, etc.) sound reproduction system operating with the system as described herein may experience a partial failure. For example, a first side such as the left-side of the sound reproduction system may cease to produce sound. As a result, audio content in the left side of the stereo panorama (or sound reproduction coverage area) in an audience area is diminished. Audio content exclusively in the left will not be heard at all. In addition, sound containment may be adversely affected if the configuration depends upon the interaction of multiple functioning components such as a functioning left side speaker to achieve the desired or target outcomes.

Upon detecting such a condition, the system can combine, or output a sum of, both the left and right input signals to drive the remaining working right-side (e.g., a functioning right side speaker, etc.) of the sound reproduction system for sound reproduction. Additionally, optionally or alternatively, frequency amplitude and phase of the signals can be adjusted to optimize monaural sound reproduction and keep the overall system in compliance with operational objectives at a venue or audio rendering environment.

### 2.12 Optimizing Speech Intelligibility In Emergency Scenario

In some operational scenarios, the system as described herein can be configured to generate or produce, in regular operations or in response to detecting no presence or event of emergency, relatively high-fidelity sound at a moderate or intermediate (or relatively low) output level contained within a relatively small area.

On the other hand, venue or environment data collected or provided by auxiliary sensors and systems may indicate—or may be used by the system to monitor or detect—a presence or an event of non-regular condition such as emergency in real time. In response, the system can dynamically (e.g., autonomously, with no or little user input, etc.) adapt its configuration to generate, produce or deliver relatively loud, clear, attention-grabbing announcements across a maximal coverage area that may be beyond the small, contained area in the normal operations. Additionally, optionally or alternatively, psychoacoustic processing or operations can be used or performed to add weight, clarity (e.g., using or determining a speech transmission index (STI) in real time for quantitative measurements at any given time, etc.), and presence to the announcements, and create directional audio effects to help guide people to safety in a venue or its surroundings.

The dynamic or autonomous system reconfiguration in response to the real-time environmental data and presence/event of non-regular condition allows the system to leverage its (e.g., audio or digital signal processing, sound containment, directed sound, etc.) capabilities to compensate for performance degradation and component failure and mitigate the impact of events such as the activation of fire suppression systems and the progressive loss of system devices or components in the overall system.

In some operational scenarios, the system can be used or deployed in the sole application of Voice Evacuation supported by system capabilities exceeding those of many other systems in use today. In some other operational scenarios, the system can be used or deployed in dual-mode or multi-mode applications with dynamic or autonomous system reconfiguration capabilities in response to detecting whether there is a presence or event of non-regular condition in an audio rendering environment or venue.

The system can be used or implemented to optimize configurations or reconfigurations of heterogeneous sound (reproduction and/or cancellation) systems—which may be sourced from multiple vendors, manufacture models and batches—for dedicated, dual-mode or multi-mode applications. This helps reduce operational costs of the system in various operational scenarios, whether the system is used to augment an existing (e.g., safety, audio, etc.) system, to provide a new system in the absence of existing infrastructure, or to deploy at temporary installations, events or venues.

### 2.13. Operational and Environmental Data

The system as described herein can be used or implemented to perform autonomous adjustment of operational parameters of various constituent systems, devices, components, operations and/or functions to ensure compliance with or within defined or applicable operational or environmental constraints, limits or thresholds which may be specific (e.g., to the venue, the neighborhood, the type of facility or space, the type of system use or application, etc.). For example, these operational parameters can be adjusted or optimized so as not to produce more than a specified broad-band weighted sound pressure level measured at a particular location during certain times of the day, not to exceed specified levels of particular frequencies at any time, etc.

In some operational scenarios, the system can operate to cause relatively high-resolution time-series operational and environmental data to be cryptographically signed and stored in an immutable ledger such as a blockchain. Such records can be used as a source of truth to certify compliance with or within defined or applicable operational or environmental constraints, limits or thresholds including—but not necessarily limited to only—noise ordinances, and energy consumptions.

In an increasingly noise-polluted world, intelligent sound management techniques as described herein can be used or implemented to enable or provide (e.g., unique, valuable, etc.) effective solutions. The system can include or operate with AI/ML systems/models to support real-time adaptive techniques as well as to support, enable or provide relatively superior audio systems, solutions, and acoustic environments.

### 3.0. Example Process Flows

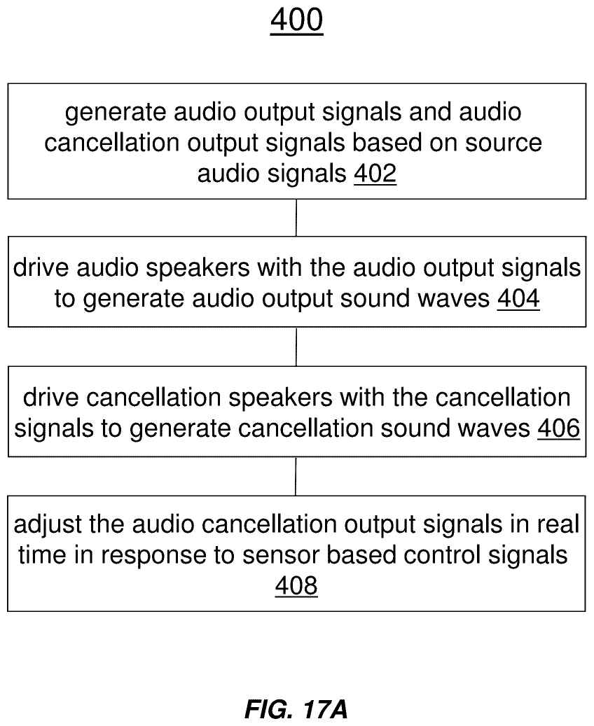

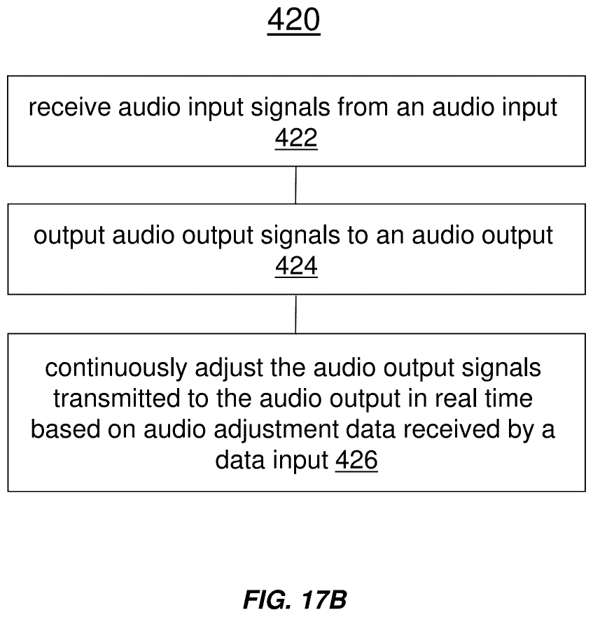

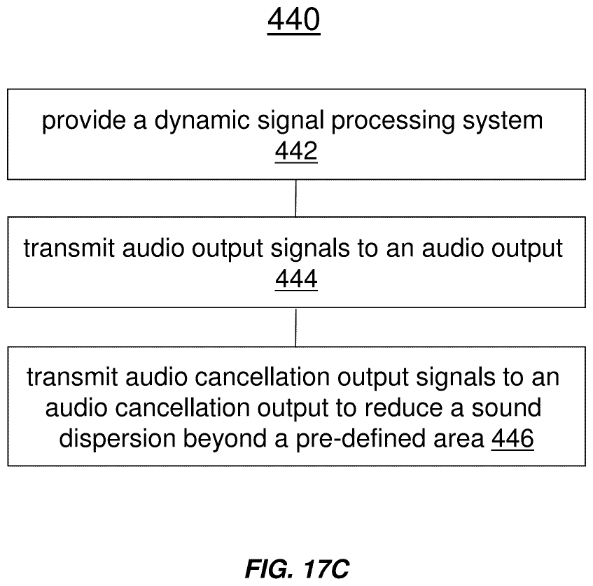

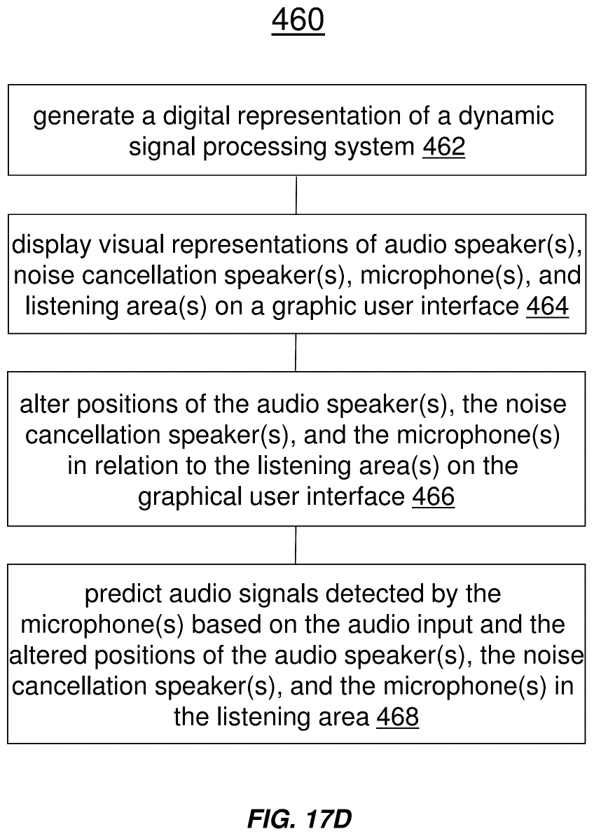

FIG. 17A illustrates an example process flow 400 for real time sound reproduction and containment according to an embodiment. In some embodiments, one or more computing devices or components may perform this process flow. In block 402, a system as described herein generates one or more audio output signals and one or more audio cancellation output signals based at least in part on one or more source audio signals.

In block 404, the system drives one or more audio speakers with the one or more audio output signals to generate audio output sound waves that are propagated to at least a specific audience area.

In block 408, the system drives one or more audio cancellation speakers with the one or more audio cancellation output signals to generate audio cancellation output sound waves, the audio cancellation output sound waves reducing, in one or more non-audience areas, a sound dispersion caused by the audio output sound waves.

In block 410, the system adjusts one or more of the audio output signals or the audio cancellation output signals in real time in response to one or more sensor based control signals, the one or more sensor based control signals generated at least in part from real time sensor data acquired by and collected from one or more physical sensors deployed in a space including the specific audience area and the one or more non-audience areas.

In an embodiment, the one or more physical sensors represent one or more of: microphones, cameras, humidity sensors, thermometers, wind sensors, etc.

In an embodiment, at least one of the specific audience areas and the one or more non-audience areas is determined based at least in part on topographical data.

In an embodiment, the specific audience area is adjusted based on where the audience is actually located in real time operations.

In an embodiment, the audio output signals are adjusted in real time to compensate for sound reproduction operational anomalies detected by the one or more physical sensors.

In an embodiment, the audio output signals are adjusted specifically to compensate for audio device capability variations that occurred over time.

In an embodiment, the system is further configured to apply real time adjustment to one or more of magnitudes or phases of specific frequency components in the audio output signals relative to the one or more source audio signals, the real time adjustments effectuating one or more of: a psychoacoustic effect to listeners in the specific audience area, noise reduction in the one or more non-audience areas, or energy saving in audio reproduction operations.

In an embodiment, the system is further configured to record operational and environmental data in an immutable ledger to certify compliance with predetermined operational limits.

In an embodiment, the system is further configured to adjust the audio output signals in real time in response to one or more natural language prompts.

In an embodiment, the system is further configured to generate training data from operational and environmental data to train an artificial intelligence (AI) model used to generate predictions in audio processing and rendering operations.

FIG. 17B illustrates an example process flow 420 according to an embodiment. In some embodiments, one or more computing devices or components may implement a dynamic signal processing system including a digital signal processor to perform this process flow. The signal processing system comprises an audio input; an audio output; a data input; and the digital signal processor coupled to the audio input, the audio output, and the data input. In block 402, the signal processor receives one or more audio input signals from the audio input. In block 404, the signal processor outputs one or more audio output signals to the audio output. In block 406, the signal processor continuously adjusts the one or more audio output signals transmitted to the audio output in real time based on audio adjustment data received by the data input.

In an embodiment, audio adjustment data includes at least one of: optimizing psychoacoustic effects for fidelity, sound containment, optimizing audio experience specific to one or more listeners, energy efficiency, or device capability changes of one or more audio devices operating with the dynamic signal processing system.

In an embodiment, the digital signal processor dynamically adjusts audio output signal in response to the audio adjustment data that includes at least one of: real-time environmental data, contextual data, and natural language prompts.

In an embodiment, the signal processing system further comprises an auxiliary sensor in communication with the digital signal processor. The auxiliary sensor provides environmental data to the digital signal processor. The digital signal processor processes the environmental data and adjusts the audio output signal in response to the environmental data.

FIG. 17C illustrates an example process flow 440 for real time sound reproduction and containment according to an embodiment. In some embodiments, one or more computing devices or components may perform some or all of this process flow. In block 442, a dynamic signal processing system is deployed or provided (e.g., at a venue, to host an audio event, etc.). The signal processing system has an audio input, an audio output, an audio cancellation output, a data input, and a digital signal processor coupled to the audio input, the audio output, the audio cancellation output, and the data input.

In block 444, audio output signals are transmitted from the digital signal processor to the audio output.

In block 446, audio cancellation output signals are transmitted from the digital signal processor to the audio cancellation output to reduce a sound dispersion beyond a predefined area. The digital signal processor dynamically adjusts the audio cancellation output signals in real-time in response to environmental and/or contextual data received by the data input.

In an embodiment, the audio output signals from the digital signal processor to the audio output are adjusted by the digital signal processor to compensate for operational anomalies of dynamic signal processing system detected by an auxiliary sensor in communication with the digital signal processor.

In an embodiment, an auxiliary sensor in communication with the digital signal processor is provided or deployed. The auxiliary sensor receives audio output data from the audio output. The audio output data is analyzed by the digital signal processor. A current deterioration in performance characteristics of sound reproduction is identified by the digital signal processor. A future deterioration in performance characteristics of sound reproduction is predicted by the digital signal processor. The audio output signals from the digital signal processor to the audio output are adjusted to compensating for the predicted future deterioration in performance characteristics of the sound reproduction components.

In an embodiment, an auxiliary sensor in communication with the digital signal processor is provided or deployed. The auxiliary sensor receives audio output data from the audio output. The audio output signals are adjusted for optimizing speech intelligibility by the digital signal processor through one or more of: dynamic adjustment of signal content, psychoacoustic weighting, or directional audio effects of the audio output signals to the audio output to enhance listener attention and comprehension.

In an embodiment, the dynamic adjustment of signal content includes dynamic adjustment of magnitudes of specific frequency components in the audio output.

In an embodiment, the digital signal processor dynamically adjusts signal processing parameters and a sound reproduction system configuration based on optimized power consumption.

In an embodiment, the digital signal processor dynamically adjusts signal processing parameters and a sound reproduction system configuration based on optimizing perceived audio fidelity.

In an embodiment, the data input receives natural language prompts that are interpreted by the digital signal processor for adjusting the audio output signals in response to the natural language prompts.

In an embodiment, the natural language prompts cause the digital signal processor to implement and secure an optimized adaptation of an operating configuration and resulting environmental effects of the dynamic signal processing system in accordance with the natural language prompts.

In an embodiment, the natural language prompts are received in real time operations from one or more designated users at a venue.

In an embodiment, contributions of multiple data sources are hierarchically weighted by the digital signal processor. The contributions are used to update a configuration of the dynamic signal processing system.

In an embodiment, an auxiliary sensor in communication with the digital signal processor is provided or deployed. The auxiliary sensor receives audio output data from the audio output. Operational and environmental data are recorded in an immutable ledger to certify compliance with predetermined operational limits.

In an embodiment, an auxiliary sensor in communication with the digital signal processor is provided or deployed. The auxiliary sensor generates measurement data of audio output data from the audio output. Performance data is generated or collected for the dynamic signal processing system based at least in part on the measurement data of the audio output data. Training data is generated from one or more of the measurement data of the audio output data and the performance data for the dynamic signal processing system. An artificial intelligence (AI) model operating with the dynamic signal processing system is trained at least in part based on the training data to optimize one or more operational parameters in audio processing and rendering operations.

In an embodiment, the AI model is used to support multiple operational modes of the dynamic signal processing system by generating one or more specific operational parameters for each of the multiple operational modes.

In an embodiment, the performance data includes operational data and environmental data for the dynamic signal processing system.

FIG. 17D illustrates an example process flow 460 according to an embodiment. In some embodiments, one or more computing devices or components may implement a system for modeling a sound reproduction system to perform this process flow. The system includes or provides a processor, a memory coupled to the processor, and a graphical user interface.

In block 462, the system generates and stores in a memory a digital representation of a dynamic signal processing system having an audio input, an audio speaker, a noise cancellation speaker, a microphone, and a listening area.

In block 464, the system displays visual representations of the audio speaker, the noise cancellation speaker, the microphone, and the listening area on the graphical user interface.

In block 466, the system alters positions of the audio speaker, the noise cancellation speaker, and the microphone in relation to the listening area on the graphical user interface.

In block 468, the system predicts by the processor, audio signals detected by the microphone based on the audio input and the altering positions of the audio speaker, the noise cancellation speaker, and the microphone in the listening area.

In an embodiment, the system is configured to further perform: storing a target magnitude curve across the listening area in the memory; determining by the processor, a predicted magnitude curve across the predefined listening area for the audio input applied to the sound reproduction system; and determining by the processor, adjustments to the sound reproduction system for dynamically maintaining the target magnitude curve for the listening area throughout a duration of the audio input.

In an embodiment, a computing device is configured to perform any of the foregoing methods. In an embodiment, an apparatus comprises a processor and is configured to perform any of the foregoing methods. In an embodiment, a non-transitory computer readable storage medium, storing software instructions, which when executed by one or more processors cause performance of any of the foregoing methods.

In an embodiment, a computing device comprising one or more processors and one or more storage media storing a set of instructions which, when executed by the one or more processors, cause performance of any of the foregoing methods.

Other examples of these and other embodiments are found throughout this disclosure. Note that, although separate embodiments are discussed herein, any combination of embodiments and/or partial embodiments discussed herein may be combined to form further embodiments.

### 4.0. Implementation Mechanism—Hardware Overview

According to one embodiment, the techniques described herein are implemented by one or more special-purpose computing devices. The special-purpose computing devices may be desktop computer systems, portable computer systems, handheld devices, smartphones, media devices, gaming consoles, networking devices, or any other device that incorporates hard-wired and/or program logic to implement the techniques. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques.

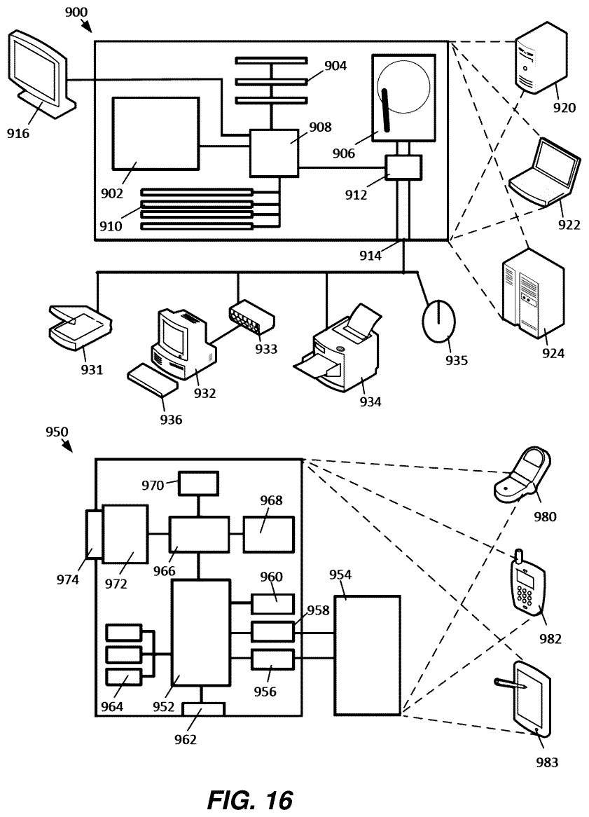

FIG. 16 shows an example of a generic computer device 900 and a generic mobile computer device 950, which may be used to implement the processes described herein, including the mobile-side and server-side processes for installing a computer program from a mobile device to a computer. Computing device 900 is intended to represent various forms of digital computers, such as laptops, desktops, workstations, personal digital assistants, servers, blade servers, mainframes, and other appropriate computers. Computing device 950 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 900 includes a processor 902, memory 904, a storage device 906, a high-speed interface 908 connecting to memory 904 and high-speed expansion ports 910, and a low speed interface 912 connecting to low speed bus 914 and storage device 906. Each of the components: processor 902, memory 904, storage device 906, high-speed interface 908, high-speed expansion ports 910, and low speed interface 912 are interconnected using various busses, and may be mounted on a common motherboard or in other manners as appropriate. The processor 902 can process instructions for execution within the computing device 900, including instructions stored in the memory 904 or on the storage device 906 to display graphical information for a GUI on an external input/output device, such as display 916 coupled to high speed interface 908. In other implementations, multiple processors and/or multiple busses may be used, as appropriate, along with multiple memories and types of memory. Also, multiple computing devices 900 may be connected, with each device providing portions of the necessary operations (e.g., as a server bank, a group of blade servers, or a multi-processor system).

The memory 904 stores information within the computing device 900. In one implementation, the memory 904 is a volatile memory unit or units. In another implementation, the memory 904 is a non-volatile memory unit or units. The memory 904 may also be another form of computer-readable medium, such as a magnetic or optical disk.

The storage device 906 is capable of providing mass storage for the computing device 900. In one implementation, the storage device 906 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 904, the storage device 906, or memory on processor 902.

The high speed controller 908 manages bandwidth-intensive operations for the computing device 900, while the low speed controller 912 manages lower bandwidth-intensive operations. Such allocation of functions is exemplary only. In one implementation, the high-speed controller 908 is coupled to memory 904, display 916 (e.g., through a graphics processor or accelerator), and to high-speed expansion ports 910, which may accept various expansion cards (not shown). In the implementation, low-speed controller 912 is coupled to storage device 906 and low-speed expansion port 914. The low-speed expansion port 914, which may include various communication ports (e.g., USB, Bluetooth, Ethernet, wireless Ethernet), may be coupled to one or more input/output devices, such as a keyboard 936 in communication with a computer 932, a pointing device 935, a scanner 931, or a networking device 933 such as a switch or router, e.g., through a network adapter.

The computing device 900 may be implemented in a number of different forms, as shown in the figure. For example, it may be implemented as a standard server 920, or multiple times in a group of such servers. It may also be implemented as part of a rack server system 924. In addition, it may be implemented in a personal computer such as a laptop computer 922. Alternatively, components from computing device 900 may be combined with other components in a mobile device (not shown), such as device 950. Each of such devices may contain one or more of computing device 900, 950, and an entire system may be made up of multiple computing devices 900, 950 communicating with each other.

Computing device 950 includes a processor 952, memory 964, an input/output device such as a display 954, a communication interface 966, and a transceiver 968, among other components. The device 950 may also be provided with a storage device, such as a Microdrive, solid state memory or other device, to provide additional storage. Each of the components computing device 950, processor 952, memory 964, display 954, communication interface 966, and transceiver 968 are interconnected using various busses, and several of the components may be mounted on a common motherboard or in other manners as appropriate.

The processor 952 can execute instructions within the computing device 950, including instructions stored in the memory 964. The processor may be implemented as a chipset of chips that include separate and multiple analog and digital processors. The processor may provide, for example, for coordination of the other components of the device 950, such as control of user interfaces, applications run by device 950, and wireless communication by device 950.

Processor 952 may communicate with a user through control interface 958 and display interface 956 coupled to a display 954. The display 954 may be, for example, a TFT LCD (Thin-Film-Transistor Liquid Crystal Display) or an OLED (Organic Light Emitting Diode) display, or other appropriate display technology. The display interface 956 may comprise appropriate circuitry for driving the display 954 to present graphical and other information to a user. The control interface 958 may receive commands from a user and convert them for submission to the processor 952. In addition, an external interface 962 may be provided in communication with processor 952, so as to enable near area communication of device 950 with other devices. External interface 962 may provide, for example, for wired communication in some implementations, or for wireless communication in other implementations, and multiple interfaces may also be used.

The memory 964 stores information within the computing device 950. The memory 964 can be implemented as one or more of a computer-readable medium or media, a volatile memory unit or units, or a non-volatile memory unit or units. Expansion memory 974 may also be provided and connected to device 950 through expansion interface 972, which may include, for example, a SIMM (Single In Line Memory Module) card interface. Such expansion memory 974 may provide extra storage space for device 950, or may also store applications or other information for device 950. Specifically, expansion memory 974 may include instructions to carry out or supplement the processes described above, and may include secure information also. Thus, for example, expansion memory 974 may be provide as a security module for device 950, and may be programmed with instructions that permit secure use of device 950. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 964, expansion memory 974, memory on processor 952, or a propagated signal that may be received, for example, over transceiver 968 or external interface 962.

Device 950 may communicate wirelessly through communication interface 966, which may include digital signal processing circuitry where necessary. Communication interface 966 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 968. In addition, short-range communication may occur, such as using a Bluetooth, Wi-Fi, or other such transceiver (not shown). In addition, GPS (Global Positioning System) receiver module 970 may provide additional navigation- and location-related wireless data to device 950, which may be used as appropriate by applications running on device 950.

Device 950 may also communicate audibly using audio codec 960, which may receive spoken information from a user and convert it to usable digital information. Audio codec 960 may likewise generate audible sound for a user, such as through a speaker, e.g., in a handset of device 950. Such sound may include sound from voice telephone calls, may include recorded sound (e.g., voice messages, music files, etc.) and may also include sound generated by applications operating on device 950.

The computing device 950 may be implemented in a number of different forms, as shown in the figure. For example, it may be implemented as a cellular telephone 980. It may also be implemented as part of a smartphone 982, personal digital assistant, a tablet computer 983 or other similar mobile computing device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

The present disclosure, in various embodiments, includes components, methods, processes, systems, and/or apparatus substantially as depicted and described herein, including various embodiments, subcombinations, and subsets thereof. Those of skill in the art will understand how to make and use the present disclosure. The present disclosure, in various embodiments, includes providing devices and processes in the absence of items not depicted and/or described herein or in various embodiments hereof, including in the absence of such items as may have been used in previous devices or processes, e.g., for improving performance, achieving ease, and/or reducing cost of implementation. Rather, as the following claims reflect, inventive aspects lie in less than all features of any single foregoing disclosed embodiment.

In an embodiment, some or all of the systems described herein may be or comprise server computer systems, including one or more computer systems that collectively implement various components of the system as a set of server-side processes. The server computer systems may include web server, application server, database server, and/or other conventional server components that certain above-described components utilize to provide the described functionality. The server computer systems may receive network-based communications comprising input data from any of a variety of sources, including without limitation user-operated client computing devices such as desktop computers, tablets, or smartphones, remote sensing devices, and/or other server computer systems.

In an embodiment, certain server components may be implemented in full or in part using cloud-based components that are coupled to the systems by one or more networks, such as the Internet. The cloud-based components may expose interfaces by which they provide processing, storage, software, and/or other resources to other components of the systems. In an embodiment, the cloud-based components may be implemented by third-party entities, on behalf of another entity for whom the components are deployed. In other embodiments, however, the described systems may be implemented entirely by computer systems owned and operated by a single entity.

In an embodiment, an apparatus comprises a processor and is configured to perform any of the foregoing methods. In an embodiment, a non-transitory computer readable storage medium, storing software instructions, which when executed by one or more processors cause performance of any of the foregoing methods.

### 5.0. Extensions And Alternatives

As used herein, the terms “first,” “second,” “certain,” and “particular” are used as naming conventions to distinguish queries, plans, representations, steps, objects, devices, or other items from each other, so that these items may be referenced after they have been introduced. Unless otherwise specified herein, the use of these terms does not imply an ordering, timing, or any other characteristic of the referenced items.

In the drawings, the various components are depicted as being communicatively coupled to various other components by arrows. These arrows illustrate only certain examples of information flows between the components. Neither the direction of the arrows nor the lack of arrow lines between certain components should be interpreted as indicating the existence or absence of communication between the certain components themselves. Indeed, each component may feature a suitable communication interface by which the component may become communicatively coupled to other components as needed to accomplish any of the functions described herein.

In the foregoing specification, embodiments of the disclosure have been described with reference to numerous specific details that may vary from implementation to implementation. Thus, the sole and exclusive indicator of what is the disclosure, and is intended by the applicants to be the disclosure, is the set of claims that issue from this application, in the specific form in which such claims issue, including any subsequent correction. In this regard, although specific claim dependencies are set out in the claims of this application, it is to be noted that the features of the dependent claims of this application may be combined as appropriate with the features of other dependent claims and with the features of the independent claims of this application, and not merely according to the specific dependencies recited in the set of claims. Moreover, although separate embodiments are discussed herein, any combination of embodiments and/or partial embodiments discussed herein may be combined to form further embodiments.

Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method for real-time sound reproduction and adjustment, the method comprising:
generating one or more audio output signals and one or more audio cancellation output signals based at least in part on one or more source audio signals;
driving one or more audio speakers with the one or more audio output signals to generate audio output sound waves that are propagated to at least a specific audience area;
driving one or more audio cancellation speakers with the one or more audio cancellation output signals to generate audio cancellation output sound waves, wherein the audio cancellation output sound waves reduce, in one or more non-audience areas, a sound dispersion caused by the audio output sound waves;
adjusting one or more of the audio output signals or the audio cancellation output signals in real time in response to one or more sensor based control signals, wherein the one or more sensor based control signals are generated at least in part from real time sensor data acquired by and collected from one or more multiple physical sensors deployed in a space including the specific audience area and the one or more non-audience areas, wherein the audio cancellation output signals include an audio cancellation output signal that is real time adjusted based at least in part on (a) first real time sensor data acquired by and collected from a first physical sensor deployed in the specific audience area and (b) second real time sensor data acquired by and collected from a second physical sensor deployed in one of the non-audience areas.

2. The method of claim 1, wherein the one or more physical sensors represent one or more of: microphones, cameras, humidity sensors, thermometers, or wind sensors.

3. The method of claim 1, wherein at least one of the specific audience areas and the one or more non-audience areas is determined based at least in part on topographical data.

4. The method of claim 1, wherein the specific audience area is adjusted based on where the audience is actually located in real time operations.

5. The method of claim 1, wherein the audio output signals are adjusted in real time to compensate for sound reproduction operational anomalies detected by the one or more physical sensors.

6. The method of claim 1, wherein the audio output signals are adjusted specifically to compensate for audio device capability variations that occurred over time.

7. The method of claim 1, further comprising: applying real time adjustment to one or more of magnitudes or phases of specific frequency components in the audio output signals relative to the one or more source audio signals, wherein the real time adjustments effectuate one or more of: a psychoacoustic effect to listeners in the specific audience area, noise reduction in the one or more non-audience areas, or energy saving in audio reproduction operations.

8. The method of claim 1, further comprising: recording operational and environmental data in an immutable ledger to certify compliance with predetermined operational limits.

9. The method of claim 1, further comprising: adjusting the audio output signals in real time in response to one or more natural language prompts.

10. The method of claim 1, further comprising: generating training data from operational and environmental data to train an artificial intelligence (AI) model used to generate predictions in audio processing and rendering operations.

11. A system comprising:
one or more processors;
one or more non-transitory computer readable media, storing computer instructions, which when executed by the one or more processors cause performance of:
generating one or more audio output signals and one or more audio cancellation output signals based at least in part on one or more source audio signals;
driving one or more audio speakers with the one or more audio output signals to generate audio output sound waves that are propagated to at least a specific audience area;
driving one or more audio cancellation speakers with the one or more audio cancellation output signals to generate audio cancellation output sound waves, wherein the audio cancellation output sound waves reduce, in one or more non-audience areas, a sound dispersion caused by the audio output sound waves;
adjusting one or more of the audio output signals or the audio cancellation output signals in real time in response to one or more sensor based control signals, wherein the one or more sensor based control signals are generated at least in part from real time sensor data acquired by and collected from one or more physical sensors deployed in a space including the specific audience area and the one or more non-audience areas, wherein the audio cancellation output signals include an audio cancellation output signal that is real time adjusted based at least in part on (a) first real time sensor data acquired by and collected from a first physical sensor deployed in the specific audience area and (b) second real time sensor data acquired by and collected from a second physical sensor deployed in one of the non-audience areas.

12. The system of claim 11, wherein the specific audience area is adjusted based on where the audience is actually located in real time operations.

13. The system of claim 11, wherein the audio output signals are adjusted in real time to compensate for sound reproduction operational anomalies detected by the one or more physical sensors.

14. The system of claim 11, wherein the audio output signals are adjusted specifically to compensate for audio device capability variations that occurred over time.

15. The system of claim 11, further comprising: applying real time adjustment to one or more of magnitudes or phases of specific frequency components in the audio output signals relative to the one or more source audio signals, wherein the real time adjustments effectuate one or more of: a psychoacoustic effect to listeners in the specific audience area, noise reduction in the one or more non-audience areas, or energy saving in audio reproduction operations.

16. The system of claim 11, further comprising: recording operational and environmental data in an immutable ledger to certify compliance with predetermined operational limits.

17. The system of claim 11, further comprising: adjusting the audio output signals in real time in response to one or more natural language prompts.

18. The system of claim 11, further comprising: generating training data from operational and environmental data to train an artificial intelligence (AI) model used to generate predictions in audio processing and rendering operations.

19. One or more non-transitory computer readable media, storing computer instructions, which when executed by one or more processors cause performance of:
generating one or more audio output signals and one or more audio cancellation output signals based at least in part on one or more source audio signals;
driving one or more audio speakers with the one or more audio output signals to generate audio output sound waves that are propagated to at least a specific audience area;
driving one or more audio cancellation speakers with the one or more audio cancellation output signals to generate audio cancellation output sound waves, wherein the audio cancellation output sound waves reduce, in one or more non-audience areas, a sound dispersion caused by the audio output sound waves;
adjusting one or more of the audio output signals or the audio cancellation output signals in real time in response to one or more sensor based control signals, wherein the one or more sensor based control signals are generated at least in part from real time sensor data acquired by and collected from one or more physical sensors deployed in a space including the specific audience area and the one or more non-audience areas, wherein the audio cancellation output signals include an audio cancellation output signal that is real time adjusted based at least in part on (a) first real time sensor data acquired by and collected from a first physical sensor deployed in the specific audience area and (b) second real time sensor data acquired by and collected from a second physical sensor deployed in one of the non-audience areas.

20. The media of claim 19, wherein real time adjustment are applied to one or more of magnitudes or phases of specific frequency components in the audio output signals relative to the one or more source audio signals, wherein the real time adjustments effectuate one or more of: a psychoacoustic effect to listeners in the specific audience area, noise reduction in the one or more non-audience areas, or energy saving in audio reproduction operations.
